(19) United States
(12) Patent Application Publication
(10) Pub. No.: US 2025/0385545 A1
(43) Pub. Date: Dec. 18, 2025

(54) LOCAL-GRID-CONSTRAINED STOCHASTIC DISPATCH OF DISTRIBUTED ENERGY RESOURCES USING GRID-EDGE DEVICES

(71) Applicant: Utilidata, Inc., Providence, RI (US)

(72) Inventors: Ashley King, East Greenwich, RI (US); Kevin Smith, Aliso Viejo, CA (US); Taylor Spalt, Sterling, VA (US); Marissa Hummon, Golden, CO (US); Yingchen Zhang, Golden, CO (US)

(73) Assignee: Utilidata, Inc., Providence, RI (US)

(21) Appl. No.: 19/051,750

(22) Filed: Feb. 12, 2025

Related U.S. Application Data
(60) Provisional application No. 63/659,686, filed on Jun. 13, 2024.

(51) Int. Cl. H02J 13/00; H02J 3/00; H02J 3/38

(52) U.S. Cl. CPC H02J 13/00006; H02J 3/004; H02J 3/38; H02J 13/00002; H02J 2203/20; H02J 2300/24

(57) ABSTRACT

This disclosure is directed to the dispatch of distributed energy resources (DER). A DER control device can be located at a site connected with an electricity distribution grid. The DER control device receives, from a data processing system of the electricity distribution grid that is remote from the DER control device, an operational constraint. The DER control device generates, for a time interval, trajectories for characteristics of electricity at the site based on the operational constraint and bounds for local power quality at the site. The DER control device detects, in real-time during the time interval, a condition related to the characteristics of electricity. The DER control device controls, in real-time and responsive to the detection, during the time interval, delivery of power from one or more DERs based on i) one or more of the trajectories, ii) the detected condition, and iii) the bounds for local power quality.

### CROSS-REFERENCES TO RELATED APPLICATIONS

This application claims the benefit of priority under 35 U.S.C. § 119 to U.S. Provisional Patent Application No. 63/659,686, filed Jun. 13, 2024, which is hereby incorporated by reference herein in its entirety.

### FIELD OF THE DISCLOSURE

This disclosure relates generally to the distribution of electricity over a utility grid, including, for example, dispatching distributed energy resources using edge devices.

### BACKGROUND

Utility distribution grids can generate and distribute electric power to various customer sites. The utility distribution grids can supply power via transmission or distribution lines to various loads at the customer sites, such as consumer electric devices or residential charging infrastructures.

### BRIEF SUMMARY OF THE DISCLOSURE

Aspects of the technical solutions described herein can dispatch distributed energy resources (DERs) using edge devices. In particular, aspects of the technical solutions described herein can provide local-grid-constrained stochastic dispatch of DERs using edge devices An edge device can refer to or include a hardware device (e.g., a computing device with one or more processors and memory) that can process data locally at the edge of a distribution grid (e.g., at or near an end load, customer, or metering device), as opposed to having to send the data to a centralized data center that is remote from the end load or customer. An edge device can be referred to or include a grid-edge device. The utility distribution grids can use metering devices (which can refer to or include meters) to observe or measure utility delivery or consumption in the grid. These metering devices, among other components within utility distribution grids, can collect samples of power delivery or consumption, such as voltage information, at a sample rate (e.g., one sample every 15 to 60 minutes). Within the utility distribution grid, DERs can be dispatched or included to allow grid operators to match (or compare) the supply of electricity with the demand. The matching of the supply of electricity to the electricity demand can be performed at a transmission level (e.g., at the transmission infrastructure or for transmission operations), where aggregated variance may be relatively low. Because the aggregated variance is relatively low, the functions or equations utilized for electricity transport can be linearized to produce or provide solution convergence via one or more linear solvers. However, it may be challenging to dispatch the DERs at the edge of the distribution level of the grid (e.g., grid edge), at the metering devices or entities consuming the supplied electricity, because certain operations or functions, such as those discussed herein for the dispatch of DERs at the transmission level, may not be carried out at the grid edge (at least not in the same manner). In other words, the dispatch of DERs at the transmission level may differ from DERs at the grid edge. For example, a central optimization including all edge DERs may be computationally complex to be performed or completed at a desired level of precision or accuracy within a predefined timespan to issue commands for the utility grid. In some cases, the DER behavior or capability may not support linearization due to the stepwise nature of the DER. In some cases, the time span between sending data from the edge device, a central solver calculating a solution, and sending a command (as a response to the data from the edge device) to the edge device may be longer than desired for effective utility grid management (e.g., for controlling electricity generation or supply). In some cases, the resource consumption for the relatively frequent transmission of both data or commands between a central hub and the edge device may be prohibitive to economic operation. In further examples, there may be privacy concerns over transmitting data of consumers or entities off-site.

To address the aforementioned factors, systems and methods of the technical solutions discussed herein can deploy or use a DER control device to receive one or more operational constraints (e.g., different from commands) from a central hub. The DER control device can be located at the grid edge or proximate to the DER, and the DER control device can be referred to as a local DER control device. The one or more operational constraints may be predefined. The DER control device can send information or data about the consumption, use or delivery of electricity at the grid edge, or other types of updates related to the status or performance of the DER control device, to the central hub periodically or in response to predefined events. The systems and methods can provide a local implementation of the DER dispatch, for instance, using stochastic scenario modeling. Multiple trajectories or predictions of the potential behavior of the constrained DERs can be mapped over a predicted (e.g., future) time window. Each trajectory can correspond to different combinations of exogenous variables and the behavior of the other DERs and loads on site, for example. The DER control device can be implemented or accomplished in multiple stages, such as by planning the dispatch of the DERs over a relatively longer time horizon (e.g., 12 hours, one day, or two days) to cover a spectrum of possible scenarios while ensuring compliance with various constraints, and dispatching the DERs in real-time according to current conditions while constraining the focus of the DERs to the longer-time-horizon schedule. The time horizons for the multi-stage (e.g., two-stage) dispatch can be continuously updated (e.g., rolling) at predefined intervals as the operation ensues.

In certain scenarios, as the number or quantity of DERs deployed on the distribution grid increases, the distribution utilities (e.g., utility grid) may not be able to operate the DERs solely via the desired economic (e.g., real-power) contribution, because the effects of the DERs on the local power quality may become increasingly more pronounced. Hence, the systems and methods of the technical solution can implement the local DER dispatch implementation presented herein to include local power quality constraints, thereby maintaining the voltage, current, or power factor within predefined bounds and minimizing or mitigating the effects of the DERs on the local power quality.

An aspect of this disclosure is directed to a system for local-grid-constrained stochastic dispatch of DER using edge devices. The system can include a DER control device located at a site connected with an electricity distribution grid, the DER control device comprising one or more processors, coupled with memory. The DER control device can receive, from a data processing system of the electricity distribution grid that is remote from the DER control device located at the site, an operational constraint. The DER control device can generate, for a time interval, a plurality of trajectories for characteristics of electricity at the site based on the operational constraint and bounds for local power quality at the site. The DER control device can detect, in real-time during the time interval, a condition related to the characteristics of electricity at the site. The DER control device can control, in real-time and responsive to the detection, during the time interval, delivery of power from one or more distributed energy sources located at the site based on i) one or more of the plurality of trajectories, ii) the detected condition, and iii) the bounds for local power quality at the site.

The DER control device can control the delivery of power in accordance with the plurality of trajectories based on a rolling-horizon comprising a plurality of time intervals within the time interval. The DER control device can generate the plurality of trajectories for the time interval having a first duration. The DER control device can generate a command to control the delivery of power from the one or more distributed energy sources based on a short-term optimization forecast having a second duration that is less than the first duration.

The DER control device can use a stochastic programming function to generate the plurality of trajectories, wherein the stochastic programming function is configured to account for uncertainty related to load and photovoltaic generation estimates. The DER control device can generate the plurality of trajectories using a regression technique.

The DER control device can generate the plurality of trajectories using a decision tree. The DER control device can generate the plurality of trajectories using a neural network. The DER control device can generate a short-term trajectory based on the condition and the plurality of trajectories. The DER control device can generate one or more commands to control the delivery of power from the one or more distributed energy sources in accordance with the short-term trajectory.

The DER control device can generate a boundary based on the plurality of trajectories. The DER control device can generate a plurality of short-term trajectories based on the condition and the plurality of trajectories. The DER control device can generate, via an optimization function applied to the plurality of short-term trajectories based on the boundary, one or more commands to control the delivery of power from the one or more distributed energy sources.

The DER control device can determine, based on the condition, to execute a multi-stage optimization process to control the delivery of power from the one or more distributed energy sources, wherein a first stage of the multi-stage optimization process comprises the generation of the plurality of trajectories for the time interval, and a second stage of the multi-stage optimization process comprises the generation of the plurality of short-term trajectories based on the condition.

The DER control device can apply the optimization function to maintain the local power quality at the site to generate the one or more commands to control the delivery of power from the one or more distributed energy sources. The DER control device can translate the short-term trajectory to a control setting to generate the one or more commands.

An aspect of this disclosure is directed to a method for local-grid-constrained stochastic dispatch of DERs using edge devices. The method can include receiving, by a DER control device, from a data processing system of an electricity distribution grid that is remote from the DER control device located at a site, an operational constraint, wherein the DER control device is located at the site connected with the electricity distribution grid. The method can include generating, by the DER control device, for a time interval, a plurality of trajectories for characteristics of electricity at the site based on the operational constraint and bounds for local power quality at the site. The method can include detecting, by the DER control device, in real-time during the time interval, a condition related to the characteristics of electricity at the site. The method can include controlling, by the DER control device, in real-time and responsive to the detection, during the time interval, delivery of power from one or more distributed energy sources located at the site based on i) one or more of the plurality of trajectories, ii) the detected condition, and iii) the bounds for local power quality at the site.

The method can include controlling, by the DER control device, the delivery of power in accordance with the plurality of trajectories based on a rolling-horizon comprising a plurality of time intervals within the time interval.

The method can include generating, by the DER control device, the plurality of trajectories for the time interval having a first duration. The method can include generating, by the DER control device, a command to control the delivery of power from the one or more distributed energy sources based on a short-term optimization forecast having a second duration that is less than the first duration.

The method can include using, by the DER control device, a stochastic programming function to generate the plurality of trajectories, wherein the stochastic programming function is configured to account for uncertainty related to load and photovoltaic generation estimates. The method can include generating, by the DER control device, the plurality of trajectories using at least one of a regression technique, a decision tree, or a neural network.

The method can include generating, by the DER control device, a short-term trajectory based on the condition and the plurality of trajectories. The method can include generating, by the DER control device, one or more commands to control the delivery of power from the one or more distributed energy sources in accordance with the short-term trajectory.

The method can include generating, by the DER control device, a boundary based on the plurality of trajectories. The method can include generating, by the DER control device, a plurality of short-term trajectories based on the condition and the plurality of trajectories. The method can include generating, by the DER control device, via an optimization function applied to the plurality of short-term trajectories based on the boundary, one or more commands to control the delivery of power from the one or more distributed energy sources.

An aspect of this disclosure is directed to a non-transitory computer readable storage medium for local-grid-constrained stochastic dispatch of DERs using edge devices. The non-transitory computer-readable medium storing processor-executable instructions that, when executed by one or more processors, cause the one or more processors to: receive, from a data processing system of an electricity distribution grid that is remote from a DER control device located at a site, an operational constraint, wherein the site connected with the electricity distribution grid managed by the data processing system; generate, for a time interval, a plurality of trajectories for characteristics of electricity at the site based on the operational constraint and bounds for local power quality at the site; detect, in real-time during the time interval, a condition related to the characteristics of electricity at the site; and control, in real-time and responsive to the detection, during the time interval, delivery of power from one or more distributed energy sources located at the site based on i) one or more of the plurality of trajectories, ii) the detected condition, and iii) the bounds for local power quality at the site.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE FIGURES

The accompanying drawings are not intended to be drawn to scale. Like reference numbers and designations in the various drawings indicate like elements having similar structure or functionality. For purposes of clarity, not every component may be labeled in every drawing. In the drawings:

FIG. 1 is a block diagram depicting an illustrative utility grid, in accordance with an implementation;

FIG. 2 is a block diagram illustrating an example system to dispatch DERs using edge devices, in accordance with an implementation;

FIG. 3 illustrates an example system for load and photovoltaic (PV) forecasting, scenario generation and selection, and DER dispatch optimization, in accordance with an implementation;

FIG. 4 illustrates example graphs of PV inverter control, in accordance with an implementation;

FIG. 5 illustrates an example diagram for scenario generation via direct-interval forecasting, in accordance with an implementation;

FIG. 6 is a flow diagram of an example method for dispatching DERs using edge devices, in accordance with an implementation; and

FIG. 7 is a block diagram illustrating an architecture for a computer system that can be employed to implement elements of the systems and methods described and illustrated herein, including, for example, aspects of the utility grid depicted in FIG. 1, the systems depicted in FIGS. 2 and 3, and the operations depicted in FIGS. 5 and 6.

The features and advantages of the present solution will become more apparent from the detailed description set forth below when taken in conjunction with the drawings, in which like reference characters identify corresponding elements throughout. Other features, aspects, and advantages of the subject matter will become apparent from the description, the drawings, and the claims.

### DETAILED DESCRIPTION

Following below are more detailed descriptions of various concepts related to, and implementations of, methods, apparatuses, and systems of local-grid-constrained stochastic dispatch of DERs using edge devices. The various concepts introduced above and discussed in greater detail below may be implemented in any of numerous ways.

In the utility distribution grid, DERs can be dispatched or included to allow grid operators to match the supply of electricity with the demand. The supply of electricity can refer to the generation and distribution of electricity within the utility grid. The demand can refer to the consumption of electricity at the grid edge, e.g., at the consumer site. In certain systems, the matching of the supply of electricity to the electricity demand can be performed at a transmission level, where aggregated variance may be relatively low. The aggregated variance can refer to combined variability or fluctuation in electricity supply or demand across various geographic areas, time periods, or sources of generation, for example. Because the aggregated variance is relatively low at the transmission level, the functions or equations utilized for electricity transport can be linearized to produce or provide solution convergence (e.g., consistent solution as the iterative process progresses) via one or more linear solvers. However, it may be challenging to dispatch the DERs at the grid edge because certain operations or functions may not be carried out at the grid edge. In other words, the dispatch of DERs at the grid edge may not be accomplished in the same manner as the dispatch of DERs at the transmission level due to, for example, at least one of the computational complexity performed at the transmission level, computational resource availability, support for linearization, the delay or latency and network resource consumption for communication between a central hub and the edge devices, or potential privacy or security concern (if transmitting data off-site).

To address the aforementioned factors, systems and methods of the technical solution discussed herein can deploy or use a DER control device that is located at the grid edge to receive one or more operational constraints (e.g., different from commands) from a central hub. The one or more operational constraints can refer to conditions, or criteria, among other constraints which may affect the operations of the local-DER control device, such as resource availability, operational efficiency, regulatory compliance, etc. The one or more operational constraints may be predefined. The DER control device can send information to the central hub periodically or in response to predefined events. The systems and methods can provide a local implementation of the DER dispatch, for instance, using stochastic scenario modeling. Multiple trajectories or predictions of the potential behavior of the constrained DERs can be mapped over a predicted (e.g., future) time window. Each trajectory can correspond to different combinations of exogenous variables and the behavior of the other DERs and loads on site, for example. The DER control device can be implemented or accomplished in multiple stages, such as by planning the dispatch of the DERs over a relatively longer time horizon (e.g., 12 hours, one day, or two days) to cover a spectrum of possible scenarios while ensuring compliance with various constraints, and dispatching the DERs in real-time according to current conditions while constraining the focus of the DERs to the longer-time-horizon schedule. The time horizons for the multi-stage (e.g., two-stage) dispatch can be continuously updated (e.g., rolling) at predefined intervals as the operation ensues.

In certain scenarios, as DER increases, the distribution utilities (e.g., utility grid) may not be able to operate DERs solely via the desired economic (e.g., real-power) contribution, because the effects of the DERs on the local power quality may become increasingly more pronounced. Hence, the systems and methods of the technical solution can implement the local DER dispatch implementation presented herein to include local power quality constraints, thereby maintaining the voltage, current, or power factor within predefined bounds and minimizing or mitigating the effects of the DERs on the local power quality.

The systems and methods of the technical solution discussed herein can include metering devices positioned or installed at or relatively approximate to the loads. Using these metering devices, the estimation of the load-to-secondary-transformer connectivity can be achieved via data processing techniques discussed herein. The systems and methods can determine the grouping of metering devices associated with at least one respective secondary transformer.

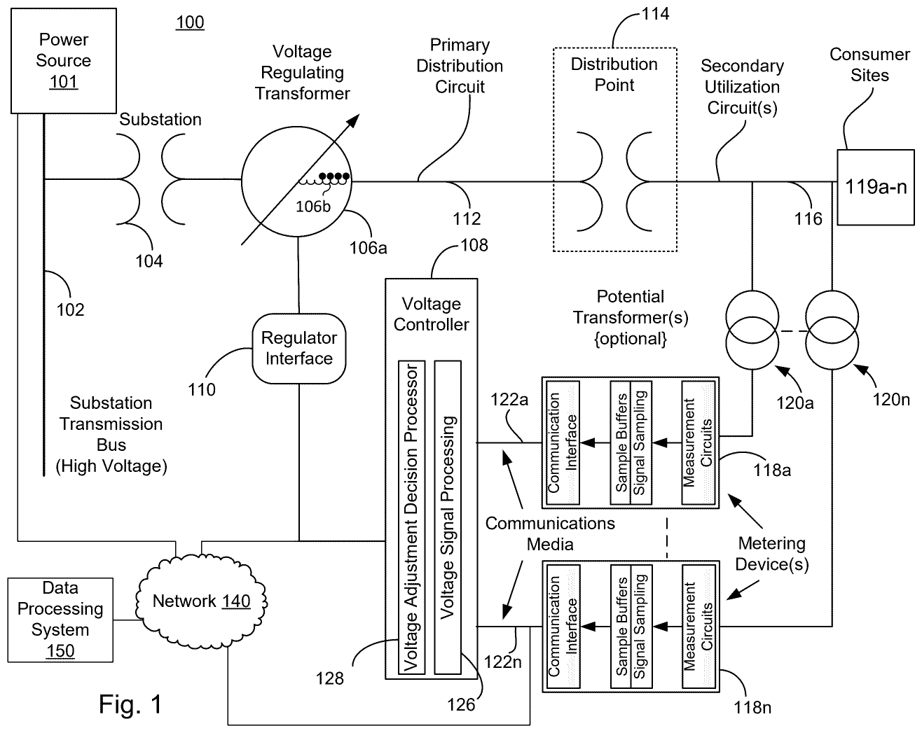

FIG. 1 depicts an example utility distribution environment. The utility distribution environment can include a utility grid 100. The utility grid 100 can include an electric distribution grid with one or more devices, assets, or digital computational devices and systems, such as a data processing system 150. In brief overview, the utility grid 100 includes a power source 101 that can be connected via a subsystem transmission bus 102 and/or via substation transformer 104 to a voltage regulating transformer 106a. The voltage regulating transformer 106a can be controlled by voltage controller 108 with regulator interface 110. Voltage regulating transformer 106a can be optionally coupled on primary distribution circuit 112 via optional distribution transformer 114 to secondary utilization circuits 116 and to one or more electrical or electronic devices 119. Voltage regulating transformer 106a can include multiple tap outputs 106b with each tap output 106b supplying electricity with a different voltage level. The utility grid 100 can include monitoring devices 118a-118n that can be coupled through optional potential transformers 120a-120n to secondary utilization circuits 116. The monitoring or metering devices 118a-118n can detect (e.g., continuously, periodically, based on a time interval, responsive to an event or trigger) measurements and continuous voltage signals of electricity supplied to one or more electrical devices 119 connected to circuit 112 or 116 from a power source 101 coupled to bus 102. A voltage controller 108 can receive, via a communication media 122, measurements obtained by the metering devices 118a-118n, and use the measurements to make a determination regarding a voltage tap settings, and provide an indication to regulator interface 110. The regulator interface can communicate with voltage regulating transformer 106a to adjust an output tap level 106b.

The utility grid 100 includes a power source 101. The power source 101 can include a power plant such as an installation configured to generate electrical power for distribution. The power source 101 can include an engine or other apparatus that generates electrical power. The power source 101 can create electrical power by converting power or energy from one state to another state. In some embodiments, the power source 101 can be referred to or include a power plant, power station, generating station, powerhouse or generating plant. In some embodiments, the power source 101 can include a generator, such as a rotating machine that converts mechanical power into electrical power by creating relative motion between a magnetic field and a conductor. The power source 101 can use one or more energy source to turn the generator including, e.g., fossil fuels such as coal, oil, and natural gas, nuclear power, or renewable sources such as solar, wind, wave, and hydroelectric.

In some embodiments, the utility grid 100 includes one or more substation transmission bus 102. The substation transmission bus 102 can include or refer to transmission tower, such as a structure (e.g., a steel lattice tower, concrete, wood, etc.), that supports an overhead power line used to distribute electricity from a power source 101 to a substation 104 or distribution point 114. Transmission towers 102 can be used in high-voltage AC and DC systems, and come in a wide variety of shapes and sizes. In an illustrative example, a transmission tower can range in height from 15 to 55 meters or more. Transmission towers 102 can be of various types including, e.g., suspension, terminal, tension, and transposition. In some embodiments, the utility grid 100 can include underground power lines in addition to or instead of transmission towers 102.

In some embodiments, the utility grid 100 includes a substation 104 or electrical substation 104 or substation transformer 104. A substation can be part of an electrical generation, transmission, and distribution system. In some embodiments, the substation 104 transforms voltage from high to low, or the reverse, or performs any of several other functions to facilitate the distribution of electricity. In some embodiments, the utility grid 100 can include several substations 104 between the power plant 101 and the consumer electoral devices 119 with electric power flowing through them at different voltage levels.

The substations 104 can be remotely operated, supervised and controlled (e.g., via a supervisory control and data acquisition system or data processing system 150). A substation can include one or more transformers to change voltage levels between high transmission voltages and lower distribution voltages, or at the interconnection of two different transmission voltages.

The regulating transformer 106 can include: (1) a multi-tap autotransformer (single or three phase), which are used for distribution; or (2) on-load tap changer (three phase transformer), which can be integrated into a substation transformer 104 and used for both transmission and distribution. The illustrated system described herein can be implemented as either a single-phase or three-phase distribution system. The utility grid 100 can include an alternating current (AC) power distribution system and the term voltage can refer to a root mean square (RMS) voltage, in some embodiments.

The utility grid 100 can include a distribution point 114 or distribution transformer 114, which can refer to an electric power distribution system. In some embodiments, the distribution point 114 can be a final or near final stage in the delivery of electric power. For example, the distribution point 114 can carry electricity from the transmission system (which can include one or more transmission towers 102) to individual consumers 119. In some embodiments, the distribution system can include the substations 104 and connect to the transmission system to lower the transmission voltage to medium voltage ranging between 2 kV and 35 kV with the use of transformers, for example. Primary distribution lines or circuit 112 carry this medium voltage power to distribution transformers located near the customer's premises 119. Distribution transformers can further lower the voltage to the utilization voltage of appliances and can feed several customers 119 through secondary distribution lines or circuits 116 at this voltage. Commercial and residential customers 119 can be connected to the secondary distribution lines through service drops. In some embodiments, customers demanding high load can be connected directly at the primary distribution level or the sub-transmission level.

The utility grid 100 can include or couple to one or more consumer sites 119. Consumer sites 119 can include, for example, a building, house, shopping mall, factory, office building, residential building, commercial building, stadium, movie theater, etc. The consumer sites 119 can be configured to receive electricity from the distribution point 114 via a power line (above ground or underground). A consumer site 119 can be coupled to the distribution point 114 via a power line. The consumer site 119 can be further coupled to a site meter 118a-n or advanced metering infrastructure (AMI). The site meter 118a-n can be associated with a controllable primary circuit segment 112. The association can be stored as a pointer, link, field, data record, or other indicator in a data file in a database.

The utility grid 100 can include metering devices, which can refer to or include site meters 118a-n or AMI. Site meters 118a-n can measure, collect, and analyze energy usage, and communicate with metering devices such as electricity meters, gas meters, heat meters, and water meters, either on request or on a schedule. Site meters 118a-n can include hardware, software, communications, consumer energy displays and controllers, customer associated systems, Meter Data Management (MDM) software, or supplier business systems. In some embodiments, the site meters 118a-n can obtain samples of electricity usage in real time or based on a time interval, and convey, transmit or otherwise provide the information. In some embodiments, the information collected by the site meter can be referred to as meter observations or metering observations and can include the samples of electricity usage. In some embodiments, the site meter 118a-n can convey the metering observations along with additional information such as a unique identifier of the site meter 118a-n, unique identifier of the consumer, a time stamp, date stamp, temperature reading, humidity reading, ambient temperature reading, etc. In some embodiments, each consumer site 119 (or electronic device) can include or be coupled to a corresponding site meter or monitoring device 118a-118n.

Monitoring devices 118a-118n can be coupled through communications media 122a-122n to voltage controller 108. Voltage controller 108 can compute (e.g., discrete-time, continuously or based on a time interval or responsive to a condition or event) values for electricity that facilitates regulating or controlling electricity supplied or provided via the utility grid. For example, the voltage controller 108 can compute estimated deviant voltage levels that the supplied electricity (e.g., supplied from power source 101) will not drop below or exceed as a result of varying electrical consumption by the one or more electrical devices 119. The deviant voltage levels can be computed based on a predetermined confidence level and the detected measurements. Voltage controller 108 can include a voltage signal processing circuit 126 that receives sampled signals from metering devices 118a-118n. Metering devices 118a-118n can process and sample the voltage signals such that the sampled voltage signals are sampled as a time series (e.g., uniform time series free of spectral aliases or non-uniform time series).

Voltage signal processing circuit 126 can receive signals via communications media 122a-n from metering devices 118a-n, process the signals, and feed them to voltage adjustment decision processor circuit 128. Although the term “circuit” is used in this description, the term is not meant to limit this disclosure to a particular type of hardware or design, and other terms known generally known such as the term “element”, “hardware”, “device”, or “apparatus” could be used synonymously with or in place of term “circuit” and can perform the same function. For example, in some embodiments the functionality can be carried out using one or more digital processors, e.g., implementing one or more digital signal processing algorithms. Adjustment decision processor circuit 128 can determine a voltage location with respect to a defined decision boundary and set the tap position and settings in response to the determined location. For example, the adjustment decision processing circuit 128 in voltage controller 108 can compute a deviant voltage level that is used to adjust the voltage level output of electricity supplied to the electrical device. Thus, one of the multiple tap settings of regulating transformer 106 can be continuously selected by voltage controller 108 via regulator interface 110 to supply electricity to the one or more electrical devices based on the computed deviant voltage level. The voltage controller 108 can also receive information about voltage regulator transformer 106a or output tap settings 106b via the regulator interface 110. Regulator interface 110 can include a processor controlled circuit for selecting one of the multiple tap settings in voltage regulating transformer 106 in response to an indication signal from voltage controller 108. As the computed deviant voltage level changes, other tap settings 106b (or settings) of regulating transformer 106a are selected by voltage controller 108 to change the voltage level of the electricity supplied to the one or more electrical devices 119.

The network 140 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, or 4G. The network standards can qualify as one or more generation of mobile telecommunication standards by fulfilling a specification or standards such as the specifications maintained by the International Telecommunication Union. The 3G standards, for example, can correspond to the International Mobile Telecommunications-2000 (IMT-2000) specification, and the 4G standards can correspond to the International Mobile Telecommunications Advanced (IMT-Advanced) specification. Examples of cellular network standards include Advance Mobile Phone System (AMPS), Global System for Mobile Communication (GSM), General Packet Radio Service (GPRS), Universal Mobile Telecommunications System (UMTS), Long Term Evolution (LTE), LTE Advanced, Mobile Worldwide Interoperability for Microwave Access (WiMAX), and WiMAX-Advanced. Cellular network standards can use various channel access methods e.g. Frequency Division Multiple Access (FDMA), Time Division Multiple Access (TDMA), Code Division Multiple Access (CDMA), or Spatial Division Multiple Access (SDMA). In some embodiments, different types of data can be transmitted via different links and standards. In other embodiments, the same types of data can be transmitted via different links and standards.

The network 140 can be any type or form of network. The geographical scope of the network 140 can vary widely and the network 140 can be a body area network (BAN), a personal area network (PAN), a local-area network (LAN), e.g. Intranet, a metropolitan area network (MAN), a wide area network (WAN), or the Internet. The topology of the network 140 can be of any form and can include, e.g., any of the following: point-to-point, bus, star, ring, mesh, or tree. The network 140 can be an overlay network which is virtual and sits on top of one or more layers of other networks 140. The network 140 can be of any such network topology as known to those ordinarily skilled in the art capable of supporting the operations described herein. The network 140 can utilize different techniques and layers or stacks of protocols, including, e.g., the Ethernet protocol, the Internet Protocol Suite (TCP/IP), the Asynchronous Transfer Mode (ATM) technique, the Synchronous Optical Networking (SONET) protocol, or the Synchronous Digital Hierarchy (SDH) protocol. The TCP/IP internet protocol suite can include application layer, transport layer, internet layer (including, e.g., IPv6), or the link layer. The network 140 can be a type of a broadcast network, a telecommunications network, a data communication network, or a computer network.

The network 140 can include computer networks such as the internet, local, wide, near field communication, metro or other area networks, as well as satellite networks or other computer networks such as voice or data mobile phone communications networks, and combinations thereof. The network 140 can include a point-to-point network, broadcast network, telecommunications network, asynchronous transfer mode network, synchronous optical network, or a synchronous digital hierarchy network, for example. The network 140 can include at least one wireless link such as an infrared channel or satellite band. The topology of the network 140 can include a bus, star, or ring network topology. The network 140 can include mobile telephone or data networks using any protocol or protocols to communicate among vehicles or other devices, including advanced mobile protocols, time or code division multiple access protocols, global system for mobile communication protocols, general packet radio services protocols, or universal mobile telecommunication system protocols, and the same types of data can be transmitted via different protocols.

One or more components, assets, or devices of utility grid 100 can communicate via network 140. The utility grid 100 can use one or more networks, such as public or private networks. The utility grid 100 can communicate or interface with a data processing system 150 designed and constructed to communicate, interface or control the utility grid 100 via network 140. Each asset, device, or component of utility grid 100 can include one or more computing devices 700 or a portion of computing device 700 or some or all functionality of computing device 700.

The data processing system 150 can reside on a computing device of the utility grid 100, or on a computing device or server external from, or remote from the utility grid 100. The data processing system 150 can communicate one or more components of the utility grid 100. The data processing system 150 can send instructions or commands to the one or more components of the utility grid 100 to execute an action or an operation, for instance, to control the electrical distribution from the power source 101 to residential or commercial areas, sites, or other downstream locations. The data processing system 150 can receive information from the one or more components of the utility grid 100 related to their operations or measurements performed by the component(s).

The data processing system 150 can reside or execute in a cloud computing environment or distributed computing environment. For instance, the data processing system 150 can be a remote device or a server. The data processing system 150 can provide information to devices within the utility grid 100 (or other systems), such as one or more operational constraints, parameters, settings, or configurations, to regulate one or more operations of the devices. The data processing system 150 can reside on or execute on multiple local computing devices located throughout the utility grid 100. For example, the utility grid 100 can include multiple local computing devices each configured with one or more components or functionality of the data processing system 150.

Each of the components of the data processing system 150 can be implemented using hardware or a combination of software and hardware. Each component of the data processing system 150 can include logical circuity (e.g., a central processing unit or CPU) that responds to and processes instructions fetched from a memory unit (e.g., memory 715 or storage device 725). Each component of the data processing system 150 can include or use a microprocessor or a multi-core processor. A multi-core processor can include two or more processing units on a single computing component. Each component of the data processing system 150 can be based on any of these processors, or any other processor capable of operating as described herein. Each processor can utilize instruction level parallelism, thread level parallelism, different levels of cache, etc. For example, the data processing system 150 can include at least one logic device such as a computing device or server having at least one processor to communicate via the network 140.

The components and elements of the data processing system 150 can be separate components, a single component, or part of the data processing system 150. For example, individual components or elements of the data processing system 150 can operate concurrently to perform at least one feature or function discussed herein. In another example, components of the data processing system 150 can execute individual instructions or tasks. The components of the data processing system 150 can be connected or communicatively coupled to one another. The connection between the various components of the data processing system 150 can be wired or wireless, or any combination thereof. Counterpart systems or components can be hosted on other computing devices.

The data processing system 150 can communicate with one or more metering devices 118 via the network 140. In some cases, the data processing system 150 can include features or functionalities of the metering devices 118. In some other cases, the data processing system 150 can be a part of the metering device 118, such that the metering device 118 can perform certain features or functionalities of the data processing system 150. For purposes of providing examples herein, the data processing system 150 may be a grid device operating in the utility grid 100, a server operating on a cloud computing environment, or a central hub for dispatching DERs using edge devices. For example, the data processing system 150 can provide or share information to a DER control device 201 controlling electrical distribution or power delivery at a site, among other devices at the grid edges or other sites. The data processing system 150 can be remote from the DER control device 201. In some configurations, the data processing system 150 can perform one or more operations or receive tasks delegated from the DER control device 201 for local-grid-constrained stochastic dispatch of DERs. In some cases, other devices or systems at the edge of the utility grid 100 can be supported or configured to perform the features or operations discussed herein, not limited to the DER control device 201 or the data processing system 150.

In certain systems, scheduling DER operation at the grid edge may be difficult due to varying or uncertainties in PV (e.g., solar panels or other solar systems) power output and electrical load at the grid edge (e.g., residential load or commercial load). To address the dynamic, sequential, decision-making-under-uncertainty problem, the systems and methods of the technical solution can integrate stochastic programming with rolling-horizon (e.g., rolling time window) control in a multi-stage optimization process. The multi-stage optimization process can be referred to as a multi-stage approach, such as a two-stage approach. The two-stage approach can refer to or include performing a first optimization (e.g., long-term optimization) in a first stage and a second optimization (e.g., short-term optimization) in a second stage, where the first stage guides or constrains the second stage. The systems and methods of the technical solution can execute the multi-stage optimization process to control power delivery at one or more sites. The systems and methods may utilize other multi-stage optimization processes, not limited to the two-stage approach discussed herein.

The rolling-horizon control can plan multiple (e.g., sequential) decisions, where each decision can be executed in a respective time period, such as a first decision in a current time, a second decision in a subsequent time, etc. The decision can refer to at least the DER operation to be performed or the schedule of the DER operation. In some cases, an optimization problem can be solved at each time step to determine one or more actions over a specified time horizon (e.g., of the rolling-horizon) and resolution. Each time step can correspond to or be associated with a respective time horizon. The decision for a current time can be executed in response to the planning of the decisions, and the planning process can be repeated at the next time step, solving a subsequent (e.g., new) optimization problem with the time horizon shifted one step forward.

Certain challenges can be addressed or solved by performing the optimization in two stages, where some of the challenges can be described in the following examples. As a first example, the forecasts or predictions over a long-horizon window may potentially change as time progresses or approaches closer to the forecasted timeframe. For instance, a forecast for conditions at 10 PM that is determined at 6 AM on the same day may likely be different from another forecast for conditions at 10 PM that is determined at 6 PM on the same day. In other words, predictions can be relatively less accurate with greater temporal distance from a predicted time. As a second example, a long-term optimization at a desired resolution to operate DERs at timescales which match the speed of changing conditions at the edge may be computationally expensive (or resource-intensive) or potentially time-prohibitive. For instance, given hardware capabilities at the edge, the process for solving the optimization may be more time-consuming than the time allotted or available before a subsequent time period to determine the next decision, e.g., in cases where a new control decision is to be made every 5 minutes, the optimization of certain systems may take 10 minutes to make a decision.

As a third example, a short-term optimization can be computed at a relatively higher temporal resolution because of the relatively shorter time horizon, thereby addressing the certain potential concerns of the second example above (e.g., resource intensive). Further, the short-term forecasts can maintain a relatively higher forecasting accuracy (e.g., compared to the long-term forecasts) because of the relatively shorter time horizon, thereby addressing certain potential concerns of the first example above (e.g., forecasting over a long-horizon window may change as time progresses). However, in some cases, a short-term schedule may not account for long-term asset planning, which may result in making decisions in the short term that lead to non-optimal conditions at a later time period. For instance, according to the short-term planning, the decision may be to discharge a battery fully, but battery reserves may be needed for later on the same day. Hence, the systems and methods of the technical solution can utilize a two-stage approach, where the first stage constrains the second, to allow at least one local DER-management device (e.g., data processing system 150) to plan or execute the DER operations.

For example, the first stage can optimize the DER operations over a long time horizon having a relatively low-temporal-resolution window (e.g., the next 24 hours at a 15-minute resolution) accounting for forecasting uncertainties via stochastic programming. The outputs from the first stage can guide (or constrain) the second stage optimization to follow or account for the long-term constraints. The second stage can optimize the DER operations (e.g., with the constraints from the first stage) over a relatively short time horizon and a relatively high-temporal-resolution window (e.g., the next 5 minutes at a 15-second resolution) to allow the (local) DERs to operate in a relatively real-time manner by matching or adjusting its operation according to the changing conditions at the edge of the utility grid 100.

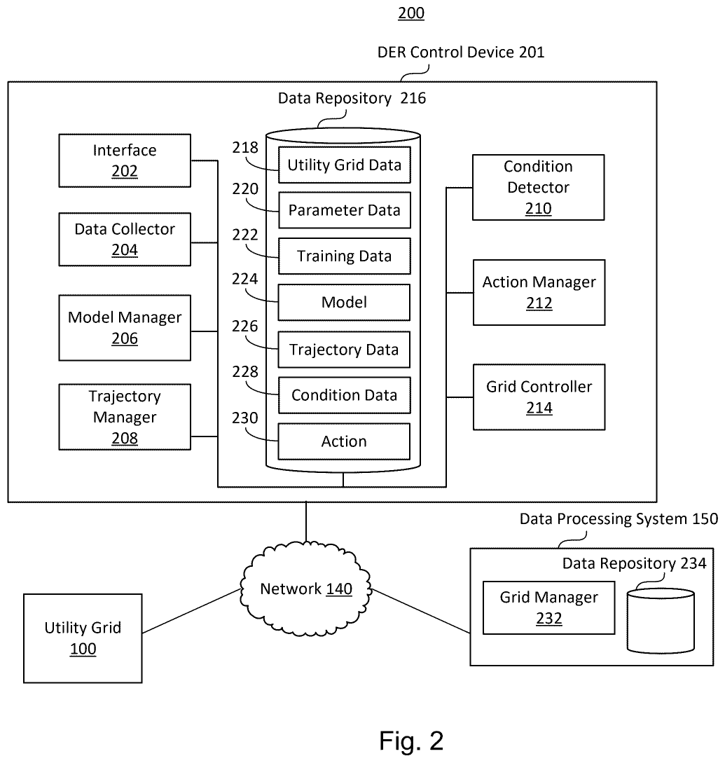

FIG. 2 illustrates a block diagram of an example system to dispatch DERs using edge devices. The system 200 can include, interface with, access, or otherwise communicate with at least one utility grid 100, at least one DER control device 201, at least one data processing system 150, or other non-limiting devices (e.g., not limited to devices or components discussed herein). The DER control device 201 can sometimes be referred to as a DER management device 201, an electricity controller, or a power control device. The DER control device 201 can include one or more components (e.g., one or more processors, memory, databases, interfaces, etc.) configured to perform features or functionalities discussed herein for dispatching DER using edge devices, such as but not limited to the multi-stage optimization process including long-term forecasting and short-term forecasting. The DER control device 201 can be a computing device local to or remote from the utility grid 100. The DER control device 201 can communicate with other components (e.g., utility grid 100 or data processing system 150) of the system 200 via the network 140. The utility grid 100, the network 140, and the data processing system 150 can be referred to in conjunction with FIG. 1. The one or more devices, components, or systems (e.g., DER control device 201, data processing system 150, metering devices 118, etc.) of the utility grid 100 or the system 200 can be composed of hardware, software, or a combination of hardware and software components.

The DER control device 201 can include or correspond to at least one metering device 118, such as one of the metering devices 118 configured to perform one or more features (e.g., collect and process electricity characteristics) for managing electricity. For example, the DER control device 201 can include or correspond to a metering device 118 configured to predict or forecast characteristics of electricity (e.g., electrical load, power consumption, or power generation) on the utility grid 100, control power delivery from distributed energy sources, or provide information to the data processing system 150 (or at least one grid device) to make decisions on the distribution of electricity to one or more sites of the utility grid 100. The DER control device 201 can be located within the utility grid 100. For example, the DER control device 201 can be positioned, installed, or provided at a location downstream from the substation 104 on the utility grid 100 that distributes electricity. For purposes of providing examples, the DER control device 201 can be installed or located at a grid edge, such as at a residential home or an entity, sometimes referred to as a site. Other sites may include other DER control devices or metering devices 118.

The DER control device 201 can receive and process data locally on the utility grid 100. In some cases, the DER control device 201 can forward or delegate one or more features or functionalities to another computing device local to or remote from the utility grid 100. For instance, the DER control device 201 can transmit data to the data processing system 150 executing in a cloud computing environment or distributed computing environment, remote from the DER control device 201. In this case, the DER control device 201 may perform a portion of the features or functionalities discussed herein, such as processing electrical data local to the utility grid 100, and the data processing system 150 may perform another portion of the functionalities, such as processing information from the DER control device 201 to generate an output.

The DER control device 201 can include one or more components for dispatching DER using edge devices, for instance, at least one interface 202, at least one data collector 204, at least one model manager 206, at least one trajectory manager 208, at least one condition detector 210, at least one action manager 212, at least one grid controller 214, and at least one data repository 216. Each of the components (e.g., interface 202, data collector 204, model manager 206, trajectory manager 208, condition detector 210, action manager 212, grid controller 214, or data repository 216) of the DER control device 201 can be implemented using hardware or a combination of software and hardware. Each component of the DER control device 201 can include logical circuity (e.g., a central processing unit or CPU) that responds to and processes instructions fetched from a memory unit (e.g., memory 715 or storage device 725). Each component of the DER control device 201 can include or use a microprocessor or a multi-core processor. A multi-core processor can include two or more processing units on a single computing component. Each component of the DER control device 201 can be based on any of these processors, or any other processor capable of operating as described herein. Each processor can utilize instruction level parallelism, thread level parallelism, different levels of cache, etc. For example, the DER control device 201 can include at least one logic device such as a computing device having at least one processor to communicate via the network 140.

The components and elements (e.g., interface 202, data collector 204, model manager 206, trajectory manager 208, condition detector 210, action manager 212, grid controller 214, or data repository 216) of the DER control device 201 can be separate components, a single component, or part of the DER control device 201. For example, individual components or elements of the DER control device 201 can operate concurrently to perform at least one feature or function discussed herein. In another example, components of the DER control device 201 can execute individual instructions or tasks. In yet another example, the components of the DER control device 201 can be a single component to perform one or more features or functions discussed herein. The components of the DER control device 201 can be connected or communicatively coupled to one another, such as via the interface 202. The connection between the various components of the DER control device 201 can be wired or wireless, or any combination thereof. Counterpart systems or components can be hosted on other computing devices.

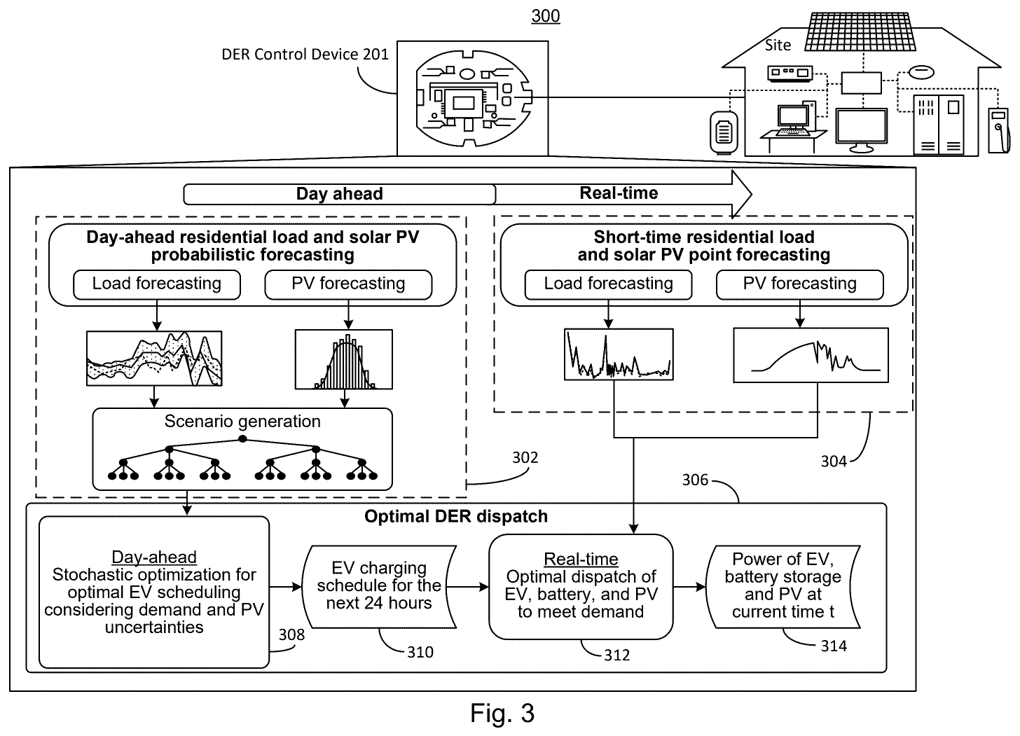

One or more operations of the DER control device 201 or the components of the DER control device 201 can include or be described in conjunction with at least FIG. 3, for instance, to perform DER dispatch. For example, FIG. 3 illustrates an example system 300 for load and PV forecasting, scenario generation and selection, and DER dispatch optimization, in accordance with an implementation. Certain features or functionalities of the systems and methods, such as the features of the DER control device 201 (or the data processing system 150) for scheduling DER operation, can be described or shown in conjunction with but not limited to FIGS. 2 and 3. In various configurations, FIG. 3 shows the features or operations of the two-stage approach for long-term forecasting and short-term forecasting, which can be performed by the DER control device 201, among other edge devices or devices located at respective sites. The functionalities can include but are not limited to at least one of (e.g., residential or home) load and PV forecasting, scenario generation and selection, or optimization. The DER control device 201 can include, correspond to, or be a part of an optimization solver configured to perform one or more operations of the two-stage (optimization) approach using one or more optimization techniques or methods. The one or more optimization techniques available for utilization can depend on the formulation of the optimization problem (e.g., mathematical problem to be solved, such as to maximize or minimize an objective function while satisfying a set of constraints). It should be noted that the optimization is performed on hardware at the grid edge, where the processing power may be constrained according to the respective edge devices (e.g., metering devices 118 or the DER control device 201) compared to other types of hardware used for optimization (e.g., personal computers or commercial servers). Given this constraint and the formulation of the optimization problem, a mixed-integer linear programming solver can be utilized by the systems and methods (e.g., the DER control device 201, the metering device 118, or the data processing system 150) herein.

The interface 202 can interface with the network 140, devices within the system 200 (e.g., data processing system 150 or utility grid 100), or components of the DER control device 201. The interface 202 can include features and functionalities similar to the communication interface of one or more metering devices 118 to interface with the aforementioned components, such as in conjunction with FIG. 1. For example, the interface 202 can include standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The interface 202 can include at least a built-in network adapter, network interface card, PCMCIA network card, EXPRESSCARD network card, card bus network adapter, wireless network adapter, USB network adapter, modem, or any other device suitable for interfacing one or more devices within the system 200 to any type of network capable of communication. The interface 202 can communicate with one or more aforementioned components to receive data from at least one of the utility grid 100, the data processing system 150, or one or more metering devices 118, such as data representative of electricity distribution to individual metering devices 118 within the utility grid 100, parameters (e.g., constraints, bounds, thresholds, or criteria) from the data processing system 150, or instructions from client devices in communication with the DER control device 201, etc.

The data collector 204 can obtain or collect electrical data within the utility grid 100. The electrical data can include data samples of an electrical waveform corresponding to electricity (e.g., electrical signals) distributed at or to the location of the data processing system 150 on the utility grid 100. The data collector 204 can receive or measure the electrical data at predefined sampling rate or resolutions, such as at least 1 kHz, 10 kHz, etc. The electrical data can include voltage data or current data, among others.

For example, the data collector 204 can obtain electrical/electricity waveform data or data set (e.g., voltage waveform data or current waveform data) corresponding to electricity distributed over the utility grid 100 and measured by at least one of the metering devices 118. The DER control device 201 can be in communication with the metering device 118 via the network 140 to receive the measured electrical data. The interface 202 can receive the electrical waveform data from the metering device 118 periodically or in response to the metering device 118 measuring the electricity or electrical waveform data distributed over the utility grid 100. The data collector 204 can obtain the electrical waveform data from the metering device 118 via the interface 202 in communication with the network 140.

In another example, the DER control device 201 can correspond to or include the metering device 118, including the features or functionalities of the metering device 118. The DER control device 201 (or the metering device 118) can include one or more sensors (e.g., voltage sensors) communicatively coupled with the DER control device 201 or one or more components of the DER control device 201. The one or more sensors can measure the electricity distributed over the utility grid 100 to generate time series of electrical data, such as at least one of voltage time series data or current time series data. The electrical time series data can include, correspond to, or be converted to electrical waveform data, such as voltage waveforms or current waveforms.

The one or more sensors can perform the measurement at a predefined sampling rate according to their configurations or capabilities. The data collector 204 can collect the waveform data measured at the predefined sampling rate, for instance, at least 1 kHz, 10 kHz, etc. The electrical data can be measured at other sampling rates, not limited to those discussed herein. The data collected by the data collector 204 can be stored in the data repository 216. Other data discussed herein, including data received, processed, generated, output, or otherwise utilized by the DER control device 201 can be stored in the data repository 216 or a remote storage device, such as a data repository 234 of the data processing system 150.

The data collector 204 can receive one or more operational constraints from the data processing system 150 or other remote devices of the utility grid 100. The operational constraints can sometimes be referred to as operational boundaries or limits, operational parameters, or long-term constraints. The operational constraints can be predefined or configured by the administrator or the user. The operational constraints can be parameters which limit, bound, guide, or otherwise constrain one or more operations of the DER control device 201, such as constraints to the forecasting of electrical load or generation, objectives for the DER dispatch (e.g., battery conservation or saving, electrical bill reduction, or grid stability management), etc. As discussed herein, the DER control device 201 can generate trajectories (e.g., forecasting or predictions) or perform DER dispatch based on or to satisfy the constraints. Other types of operational constraints can be applied or utilized, not limited to those discussed herein.

For example, the constraints can include, but are not limited to, at least one of electric vehicle (EV) constraint(s), energy storage (ES) constraint(s), PV constraint(s), grid constraint(s), etc. The EV constraint can include at least one of discharging rate, charging rate, state-of-charge (SoC) limits or range (e.g., 20% to 80%), or target SoC, among others. The ES constraint can include at least one of discharging rate, charging rate, SoC limits, etc. The PV constraint can include at least one of minimize curtailment, max generation rate, etc. The grid constraint can include at least one of power-import limits, power-export limits, power quality constraints (e.g., local-voltage boundaries), etc. Other constraints can be utilized or discussed herein for DER dispatch.

In some cases, the data collector 204 can receive or collect forecasting or trajectories generated by the trajectory manager 208 or other devices within the system 200. For example, the data collector 204 can receive a plurality of trajectories generated by the trajectory manager 208 for storage. The plurality of trajectories can be retrieved to generate one or more short-term trajectories. In another example, the data collector 204 can receive the one or more short-term trajectories generated by the trajectory manager 208 for storage. The one or more short-term trajectories can be retrieved and utilized for DER dispatching or scheduling, e.g., scheduling EV charging, ES discharging, etc.

The model manager 206 can generate, train, validate, execute, or otherwise manage one or more models or techniques for executing one or more operations discussed herein. The model manager 206 can manage the one or more models for at least one of forecasting power consumption (e.g., home load) or power generation (e.g., PV output) at the site. The one or more models can be used for scenario generation discussed herein, for instance, to account for the variabilities (or uncertainties) in the forecasting. The one or more models or techniques can include, but are not limited to, a regression technique, decision tree, neural network, support vector machine (SVM), random forest, or k-means clustering. The one or more models can be trained using machine learning or statistical methods.

The model manager 206 can train the model using at least one of historical data. The model manager 206 can obtain training data from the data processing system 150 or other devices via the network 140. The historical data can include or be grouped into different data sets, such as a training data set, validation data set, and testing data set. For example, the model manager 206 can receive training data including historical time series data of characteristics of electricity, such as information related to power consumption, power generation, power storage at the site. The model manager 206 can receive the weather data, seasonal information, geographical location of the site, configuration of the PV (e.g., orientation, tilt, type, efficiency, or size), energy storage type or size, types of EV charger (e.g., level 1, level 2, or level 3 charger), charging rate, discharge rate, etc., associated with the historical time series data of the site.

Based on the training data, the model manager 206 can identify patterns or signatures related to the power or electricity consumption at the site, such as occurrences of EV charging including the day in the week or a time of the day, electricity consumed during the day or night, amount of electricity generated by the PV during the day according to different weather conditions or season of the year, or increases or decreases in electricity consumption throughout the day or week. In some cases, the model manager 206 can detect anomalies or outliers in the data, such as electrical spikes or drops, which may be due to sensor drift, measurement error, or a non-repeating or singular event. The non-repeating or singular event can involve an electrical event that occurs either once or without a pattern, such as increase or spike in electrical consumption during a holiday (e.g., temporary increases in users at the site), maintenance performed at the site (e.g., for the PV or energy storage), or other types of irregular events.

The model manager 206 can train the model to correlate the patterns or signatures with their subsequent electrical events based on the historical data. The model manager 206 can utilize the validation data set to assess the performance of the model during training and prevent overfitting. The model manager 206 can utilize the test data set to provide an unbiased assessment of the model performance given new, unseen data, such that the model can be deployed, retrained or updated accordingly.

In some cases, the model manager 206 can obtain (pre-)trained models from the data processing system 150 or other devices within the network 140. The model manager 206 may obtain models from one or more other metering devices 118. The model manager 206 can share the trained model to one or more other metering devices 118 or upload the trained model to the data processing system 150 or the server, for example. The model manager 206 can receive updates or an updated model from the data processing system 150, one or more metering devices 118, or other devices in the network 140. The model manager 206 may train the model locally for the site, independent of other model on other metering devices 118. In some configurations, the models may be shared between the DER control device 201 and other metering devices 118. The features or operations for training or using the model can be discussed herein.

The trajectory manager 208 can perform a multi-stage optimization process involving the generation of one or more trajectories for characteristics of electricity at the site. The output of the trajectory manager 208, such as one or more trajectories. The one or more trajectories can include one or more long-term trajectories (e.g., long-term forecasting or day-ahead forecasting) or at least one short-term trajectory (e.g., short-time forecasting or real-time forecasting). In some cases, the trajectory can refer to either the long-term trajectory or short-term trajectory. In some other cases, the trajectory can refer to the long-term trajectory (e.g., for or including scenario generation and selection), independent of the short-term trajectory. The one or more trajectories can be utilized to perform DER dispatch. The trajectory manager 208 can generate the trajectories based on or according to at least one operational constraint and one or more bounds for local power quality at the site, etc. The local power quality can be described herein in conjunction with at least FIG. 3, for instance, serving to keep at least one of but not limited to voltage, current, or power factor within user-defined bounds.

The multi-stage optimization process can include but is not limited to the two-stage optimization, e.g., a first stage optimization and a second stage optimization. The multi-stage optimization process can involve at least operations 302, 304, and 306. The output of the first stage optimization can be utilized by the second stage optimization to perform DER dispatch, for example. The information related to the first stage optimization and the second stage optimization for the two-stage approach can describe, include, or involve the formulation and interconnection between these two stages. In the first stage optimization, a long-time-horizon, low-temporal-resolution optimization can be used to satisfy long-term constraints (e.g., saving battery capacity for the evening) and objectives (e.g., having the lowest total electric bill for the day, instead of just for the next hour). The forecasting, scenario generation, objective function, and constraints can be provided as follows.

In various cases, the first step of the first stage can involve or include the trajectory manager 208 generating load (e.g., residential or home load) or PV forecasts over a predefined time horizon (e.g., time period, time window, or timeframe) at a predefined resolution. The generated load or PV forecasts can be trajectories generated by the trajectory manager 208, e.g., the values of the load or PV can be at least one trajectory in a time series. The ability to forecast the load or the PV output into the future or later time period can be assumed for purposes of providing examples herein.

For example, at least one suitable technique, method, or model for time series forecasting can be utilized to perform the forecasting over the predefined time horizon at the predefined resolution, such as but not limited to at least one of autoregressive moving average models, autoregressive integrated moving average, seasonal autoregressive integrated moving average, etc. Information that provides a model with a contextualization of the optimization problem can improve the accuracy of the model, e.g., the inclusion of forecasted temperature, weather conditions, or daylight time can affect the prediction of the residential load or PV output. The contextual information can be fed to the model for training purposes.

The systems and methods (e.g., the DER control device 201 or the trajectory manager 208) can address the uncertainty in the forecasts. For example, the trajectories, including load and PV forecasts, may have uncertainty in the estimation or prediction of load and PV generation. This uncertainty can be accounted for using stochastic optimization (e.g., stochastic programming function), involving generating a set of scenarios (e.g., varying forecasts, as discussed herein for examples on how to generate the scenarios from the forecasts) and creating an optimal schedule for each scenario, thereby generating a distribution of optimal schedules. The load and PV forecasting and the scenario generation can be part of operation 302. The generation of the set of scenarios can correspond to or be a part generating the trajectories.

This distribution (or trajectories) can be used to at least one of guide (e.g., via “soft boundaries” included as or corresponding to terms in the objective function) or constrain (e.g., via hard constraints or hard boundaries) the second stage. The boundaries can be calculated from the mean and standard deviation of multiple or all of the optimal schedules at each time step, for example. The objective function can include or be used to at least one of minimize the total electricity consumption or cost, reduce the amount of PV generation that is curtailed, or smooth the net-load profile, among others. The trajectory manager 208 can generate at least one short-time trajectory and the action manager 212 (or the grid controller 214) can select or execute a DER dispatch action (e.g., control the delivery of power from distributed energy source(s)) at the site based on at least the boundaries and the trajectories (e.g., scenarios) from the first stage.

When using soft boundaries for the second stage, the action manager 212 (e.g., at operation 306) may generate or select at least one action (or command) to control the power delivery at the site which satisfies at least a portion of the boundaries. The soft boundaries can be coded or included in the objective function, such that the result of the objective function follows or obey the soft boundaries, for example. When using the hard constraints for the second stage, the action manager 212 (e.g., at operation 306) may generate or select at least one action (or command) to control the power delivery at the site which satisfies all of the boundaries from the first stage. The hard constraints can be boundaries or thresholds, where values or solutions exceeding these boundaries may be deemed infeasible and excluded from the set of potential solutions or results (among which the optimal result can be selected for a given iteration).

In various configurations, the ability to generate possible scenarios (e.g., variations in the forecasts) can be utilized to account for the inherent uncertainty in forecasting. Examples for generating the scenarios can be provided as follows, e.g., at least at operation 302. For example, at operation 302, the trajectory manager 208 can perform scenario generation via random sampling. The trajectory manager 208 can generate load and PV forecasts as expected values with confidence intervals (e.g., 90%). The trajectory manager 208 can generate scenarios by (e.g., randomly) sampling at each time step (e.g., time instance) from a normal distribution with mean and standard deviation corresponding to the expected value and confidence interval of the forecast at the respective time step.

In another example, the trajectory manager 208 can perform scenario generation via moment matching. The moment matching technique can be performed or achieved by generating scenarios that have one or more statistical moments (e.g., mean, standard deviation, skewness, kurtosis, or correlation) approximately equal to (or around) those (e.g., one or more statistical moments) of the original forecasts. For instance, the trajectory manager 208 can perform the moment matching technique by minimizing the squared difference between the original moments and the moments of the scenarios generated according to the following formula:

min[(mn*−mnₛ)²+(sd*−sdₛ)²+(skw*−skwₛ)²+(kur*−kurₛ)²+(cor*−corₛ)²].

In this formula, the * can denote the statistical moments computed from past data, and the s can denote the statistical moments of each scenario. Any value in the generated tree that is outside the boundary constraints can be adjusted, changed, or forced to the nearest boundary value.

In yet another example, the trajectory manager 208 can perform the scenario generation via historical sample covariance. Using the historical-sample-covariance approach to produce the scenarios can involve multiple steps, such as but not limited to four steps. For instance, as a first step, the trajectory manager 208 can compute the sample covariance matrix from historical load and PV data. As a second step, the trajectory manager 208 can replace the matrix diagonals with the variances predicted from the load and PV forecasts. As a third step, the trajectory manager 208 can identify the closest positive-semidefinite matrices (e.g., via eigen decomposition) to those from the second step. As a fourth step, the trajectory manager 208 can sample the multivariate, normal distribution with the matrices from the third step as the covariance matrices, and with means from the load and PV forecasts.

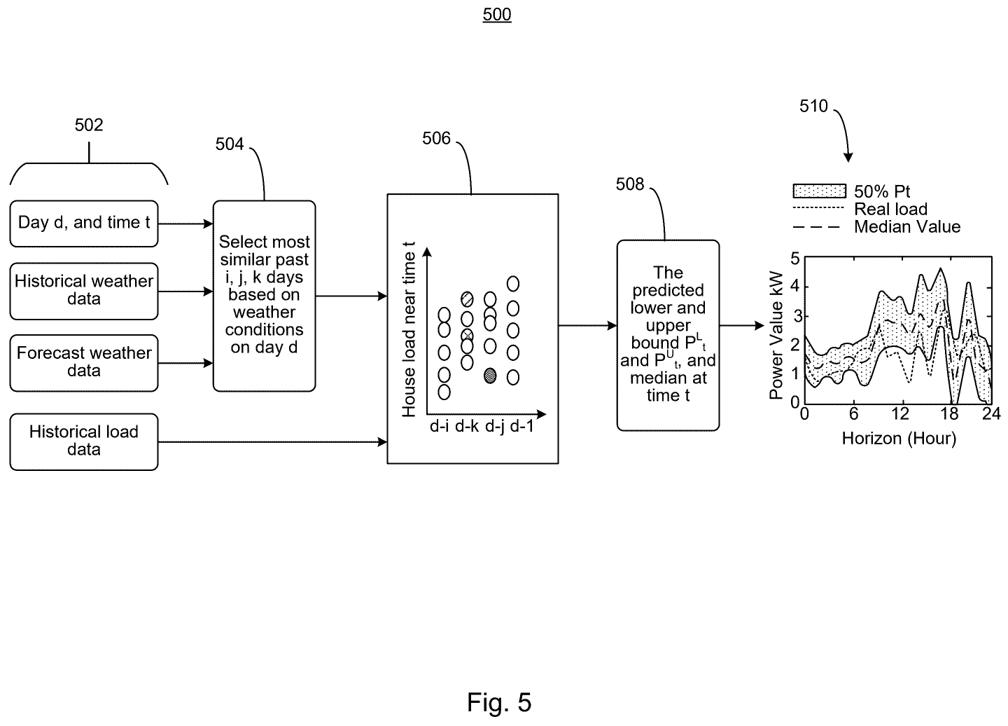

In further examples, the trajectory manager 208 can perform the scenario generation via direct-interval forecasting. FIG. 5 illustrates an example diagram 500 for scenario generation via direct-interval forecasting, in accordance with an implementation. The direct-interval scenario generation can be a modification of direct-interval forecasting, such as described in conjunction with at least FIG. 5, for example. For generating each point in time in the forecast of this scenario, the following steps can be performed using one or more input data (e.g., 502), such as at least one of time and day, historical weather data, forecast weather data, or historical load data, among others. For example, in a first step, the trajectory manager 208 can select a number of points per time step from the historical (load) data. The number of points (or data values) per time step can be predefined or configured by the operator or administrator of the DER control device 201 or the data processing system 150, for example. For instance, as shown in 506, the trajectory manager 208 can select five points per time step, provided as [t−2, t−1, t, t+1, t+2], where t can represent a time within a day. The time t can be the time being forecasted by the trajectory manager 208, for example. The time steps can represent the time instances around the time t for various scenario generation based on the forecasting (e.g., load forecasting and/or PV forecasting). Each time step can be incremented or decremented by a time interval or sampling solution. In this example, for a 15-minute sampling resolution where t=6 AM, the points from a given day in the data history can include [5:30 AM, 5:45 AM, 6 AM, 6:15 AM, 6:30 AM]). It should be noted that the trajectory manager 208 can select more or less than five points as the number of data values for the set of data values, in 506, at any sampling resolution, such as 6 points at 10-minute sampling resolution, 10 points at 6-minute sampling resolution, etc. Decreasing the sampling resolution or increasing the number of data points can increase the granularity of the data points. Increasing the sampling resolution or decreasing the number of data points can reduce the granularity.

In a second step, at 504, the trajectory manager 208 can select one or more days (e.g., labeled as d−i, d−k, d−j, and d−1, in 506) at which to select the points in time from the first step according to at least the forecast weather conditions. The trajectory manager 208 can select the days from a predefined historical time period, such as two weeks, three weeks, or four weeks prior to the current day. The number of days to select can be predefined. In some cases, the trajectory manager 208 can select any number of days within the predefined historical time period that have similar weather conditions around the time t or the plurality of time steps, e.g., similar weather conditions at the or around the points from a given day.

For example, the trajectory manager 208 can select the four days with relatively similar weather conditions from the past two weeks, as part of the scenario generation. In a third step, in combination of the first and second steps (e.g., selecting the number of data points and the number of days with similar weather conditions), the trajectory manager 208 can generate, output, or provide a set of data values, such as shown in 506. The trajectory manager 208 can provide the set of data values to the administrator or operator for selecting or specifying which of these values to be selected for at least one point in time for a particular scenario, e.g., the mean value can be selected. It should be noted that the trajectory manager 208 can select any number of days with relatively similar weather conditions, for instance, as part of the scenario generation, not limited to four days. The trajectory manager 208 can consider any type of weather condition, such as sunny, raining, cloudy, etc.

These steps can be depicted or described in conjunction with at least FIG. 5. The process above can generate a single value for each time step in the forecasted scenario. To generate multiple scenarios, the selections used for each step can be varied, with each combination generating a new scenario. Varying the selections can include selecting different types of weather conditions, time of day, number of data points, or sampling resolution to generate a plurality of data sets, for example. The trajectory manager 208 can generate multiple scenarios for a predicted time window, such as the next 24 hours, a subsequent day, subsequent days, or a subsequent week, etc.

With the data sets, at 508, the trajectory manager 208 can determine the predicted lower bound Pₜ^{L}, upper bound Pₜ^{L}, and median at time t. The upper bound can include the highest value in the data sets at time t. The lower bound can include the lowest value in the data sets at time t. The trajectory manager 208 can predict the lower bounds, upper bounds, and median (e.g., 50^{th} percentile, labeled as 50% Pt) for a plurality of time t, such as for 24 hours in a predicted day, as shown in 510. As shown in 510, the trajectory manager 208 can predict or forecast (real) load at the site (the real load in 510 is provided as an illustrative example). Although the scenario generation process described in conjunction with FIG. 5 involves the historical load data and load forecasting, it should be noted that the trajectory manager 208 can perform the various operations of the scenario generation process using either load data or PV data for the load forecasting or PV forecasting, respectively.

In various cases, in the first stage after generating the scenarios at operation 302, the action manager 212 can perform a long-term optimization, including scheduling the residential DER using stochastic optimization, at operation 308. Scheduling the residential DER using the stochastic optimization allows the incorporation of uncertainty in the load and PV forecasts. The stochastic optimization can involve or include rolling-horizon control. The rolling-horizon control can include planning multiple decisions (e.g., for DER dispatch) for execution in respective time periods. One or more actions or decisions can be determined at each time step over a specified time horizon (e.g., of the rolling-horizon) and resolution, where each decision can be executed in a respective time step or period. The decision for a current time or for each time step subsequent to the current time can be executed in response to the planning of the decisions, and the planning process can be repeated at the next time step, solving a subsequent optimization problem with the time horizon shifted one step forward.

As an example, at operation 310, scheduling the DER can include scheduling EV charging considering the demand and PV uncertainties, e.g., uncertainties of power consumption and power generation at the site. Scheduling EV charging can refer to scheduling or planning to deliver power to the EV charger or the EV from the charger at the scheduled time. The EV charging can be scheduled for a specified time horizon, such as 12 hours, 24 hours, 48 hours, etc., where each EV charging control can be scheduled for a respective time step over the specified time horizon. The action manager 212 can perform stochastic optimization for optimal EV charging scheduling. In some cases, the grid controller 214 can control the delivery of power with the trajectories based on a rolling-horizon including a plurality of time intervals within a time interval. For example, for a 24-hour time horizon (e.g., the time interval) with a resolution of 15 minutes (e.g., the plurality of time intervals), the action manager 212 or the grid controller 214 can schedule DER (or other power delivery controls) for each 15 minutes time step for the 24-hour time interval. The DER schedules (e.g., settings or configurations of the DER) for each time step may differ from other time steps according to the forecasted load and PV at the site, for example.

It should be noted that other types of DER scheduling can be performed by the action manager 212 or other devices within the systems 200 (e.g., metering devices 118 or data processing system 150), not limited EV charging scheduling, such as power storage management for scheduling power delivery from a local distributed energy sources (e.g., local power supply) or from the utility grid 100, or scheduling power consumption by other local appliances. An objective function of the first stage optimization can be provided in formula (1), as an example. The objective function can be at least one boundary generated based on the trajectories (e.g., forecast or scenarios). The objective function can be applied to the trajectory, forecast, or scenario, for instance, to optimize the scheduling for the desired purposes or outcomes.

$$\{ {\sum }_{iϵH} ( {ρ}_{tariff}^{i} {P}_{net}^{i} + {λ}_{PV} {P}_{PV , curtail}^{i} + {λ}_{reg} \vert {P}_{net}^{i} \vert ) \qquad ( 1 )$$

In formula (1), ρⁱ_{tariff} can denote the electricity tariff as a function of time step i forming the set of total time steps of the forecasted period H. The Pⁱₙₑₜ (e.g., a first term of the objective function) can denote the net load (e.g., positive values indicating energy drawn from the utility grid 100 and negative values indicating energy sent back to the utility grid 100). The λ_{PV} (e.g., a second term of the objective function) can denote a user-defined (or predefined) term (e.g., ranging from [0:1]) that penalizes the amount of PV curtailed from the total production (e.g., Pⁱ_{PV,curtail}≤Pⁱ_{PV}≥0). The λ_{reg} (e.g., a third term of the objective function, ranging from [0:1]) can denote a lasso-regularization term used to smooth the absolute value of the net load. As such, the formula (1) can have an individual objective associated with each term. The objective function can be used to generate or select a command to control the power delivery from one or more distributed energy sources to the site, e.g., DER dispatch. In some cases, at least a portion of the objective function can be utilized in the second stage optimization.

For example, the first term of the objective function can minimize the total electricity consumption or cost. The second term can reduce the amount of PV generation that is curtailed. The third term can smooth the net-load profile. The net load profile can be for tariffs which determine rates based on the maximum (e.g., not total) power in a given time period, for instance, to avoid ramp-rate violations (e.g., both power drawn or fed back to the grid) or excessive cycling of energy storage units. The coefficients λ_{PV} and λ_{reg} may be (empirically) derived, and default to 1 and 1e−3, respectively, as example values. In some cases, λ_{PV} can be relatively large compared to ρ_{tariff} because there may be minimal economic downside to using all the available solar power and a positive environmental gain from not curtailing it. In some cases, λ_{reg} can be relatively smaller than ρ_{tariff} to minimize or avoid increasing the electricity cost, for example.

At least one additional term can be included to support demand-response and virtual-power-plant (VPP) programs. For instance, if the objective of the program is to reduce usage during a peak time, additional penalties can be added during that time to ρ_{tariff}. In another example, if the objective is to provide a specified total power output, a VPP penalty term can be added or included to the objective, such as provided in formula (1b), provided below for reference.

$$\{ {\sum }_{iϵH} ( {ρ}_{tariff}^{i} {P}_{net}^{i} + {ρ}_{VPP}^{i} \vert Δ {P}_{net , target}^{i} \vert + {λ}_{PV} {P}_{PV , curtail}^{i} + {λ}_{reg} + \vert {P}_{net}^{i} \vert ) \qquad ( 1 b )$$

The ρⁱ_{VPP} can denote the penalty (e.g., cost per electrician consumption, e.g., $/kW) for missing or failing to meet the target power. The |ΔPⁱ_{net,target}| can denote the absolute difference between the actual and target net power.

One or more of the formulas or one or more variables of the formulas discussed herein can be a part of one or more operational constraints for generating a plurality of trajectories (e.g., generating scenarios) for DER scheduling. Other formulas or variables discussed herein can be utilized as part of the operational constraints for scenario generation or DER scheduling, such as but not limited to at least one of formulas (2)-(18). In some configurations, the net load can be constrained using formulas (2) and (3), provided below for reference.

$${P}_{net}^{i} - {P}_{EV}^{i} - {P}_{L}^{i} - {P}_{ES}^{i} + {P}_{PV}^{i} = 0 \qquad ( 2 )$$

$${P}_{net}^{min} \leq {P}_{net}^{i} \leq {P}_{net}^{max} \qquad ( 3 )$$

The Pⁱ_{EV} can denote the EV power (e.g., positive values indicate charging the EV and negative values discharging power to the grid). The Pⁱ_{L} can denote the forecasted site load (e.g., ≥0). The Pⁱ_{ES} can denote the ES power (e.g., same sign convention as the EV). The Pₙₑₜ^{min} be less than zero when the site (e.g., residential site or grid edge) is allowed to sell energy back to the utility grid 100. The Pₙₑₜ^{max} can be set by the hardware or the grid limits. The EV (e.g., the charging of EV or power delivery via the EV charger) can be constrained according to one or more of the formulas (4)-(10), as provided below for reference.

$${E}_{EV}^{min} \leq {E}_{EV}^{i} \leq {E}_{EV}^{max} \qquad ( 4 )$$

$$- {{E}^{i}}_{EV} \leq - {E}_{EV}^{Target} for i \geq {T}_{target} \qquad ( 5 )$$

$${E}_{EV}^{i} - {E}_{EV}^{i + 1} + {ϵ}_{EV} {P}_{EV , charge}^{i} * Δ T + \frac{1}{{ϵ}_{EV}} {P}_{EV , discharge}^{i} * Δ T = 0 \qquad ( 6 )$$

$${P}_{EV}^{i} - {P}_{EV , charge}^{i} - {P}_{EV , discharge}^{i} = 0 \qquad ( 7 )$$

$${P}_{EV}^{min} \leq {P}_{EV , discharge}^{i} \leq 0 \qquad ( 8 )$$

$$0 \leq {P}_{EV , charge}^{i} \leq {P}_{EV}^{max} \qquad ( 9 )$$

$${P}_{EV , discharge}^{i} \vert {P}_{EV , charge}^{i} = 0 \qquad ( 10 )$$

The

$${E}_{EV}^{min} and {E}_{EV}^{max}$$

can denote une user-defined or hardware-defined minimum or maximum EV-charge levels (e.g., energy in kWh). The Eⁱ_{EV} can denote the charge of the EV. The E_{EV}^{Target} can denote the target charge for the EV to have before a set time (e.g., T_{target}). The variables T_{target} and E_{EV}^{Target} variables can be predefined to be attainable within the horizon time. The ∈_{EV} can denote the charge/discharge efficiency, which may be predefined for the site (or the EV charger of the site). The Pⁱ_{EV,charge} and Pⁱ_{EV,discharge} can denote the power rates while charging and discharging, respective. The power rates may be predefined. The P_{EV}^{min} and P_{EV}^{max} can denote the minimum and maximum charging rates, respectively. The ΔT can denote the time step between i and i+1. As such, the formulas (4) and (5) can bound the charge of the EV, the formula (6) can enforce energy conservation, formulas (7)-(9) can provide the charging or discharging limits, and the formula (10) can stipulate that the EV cannot charge and discharge simultaneously. The E_{EV}ⁱ⁼⁰ can be measured or determined at the time of initialization.

In some configurations, the ES can be constrained similarly to the EV. For example, the following formulas for constraining the ES can be provided below for reference.

$${E}_{Es}^{min} \leq {E}_{ES}^{i} \leq {E}_{ES}^{max} \qquad ( 11 )$$

$${E}_{ES}^{i} - {E}_{ES}^{i + 1} + {ϵ}_{ES} {P}_{ES , charge}^{i} * Δ T + \frac{1}{{ϵ}_{ES}} {P}_{ES , discharge}^{i} * Δ T = 0 \qquad ( 12 )$$

$${P}_{ES}^{i} - {P}_{ES , charge}^{i} - {P}_{ES , discharge}^{i} = 0 \qquad ( 13 )$$

$${P}_{ES}^{min} \leq {P}_{ES , discharge}^{i} \leq 0 \qquad ( 14 )$$

$$0 \leq {P}_{ES , charge}^{i} \leq {P}_{ES}^{max} \qquad ( 15 )$$

$${P}_{ES , discharge}^{i} \vert {P}_{ES , charge}^{i} = 0 \qquad ( 16 )$$

The E_{ES}ⁱ⁼⁰ can be measured at the time of initialization. The PV system can be constrained according to formulas (17)-(18), provided below for reference.

$$0 \leq {P}_{PV}^{i} \leq {P}_{PV}^{max , i} \qquad ( 17 )$$

$${P}_{PV}^{max , i} - {P}_{PV}^{i} - {P}_{PV , curtail}^{i} = 0 \qquad ( 18 )$$

The P_{PV}^{max,i} can denote the forecasted value at time step i, which may not exceed the rated power of the system. In some configurations, the optimization can include local power quality constraints (or bounds) to ensure optimal grid conditions. The local power quality constraints can sometimes be referred to as bounds for local power quality. The local power quality constraints can be used, at least in part, for generating the plurality of trajectories or scenarios for DER dispatch. The local power quality constraints can be described in conjunction with the formulas provided below for reference.

$${V}^{min , i} \leq {V}^{i} \leq {V}^{max , i} \qquad ( 19 )$$

$${V}^{i + 1} - {{V}^{i} ( \frac{dv}{dP} )}^{1} ( {P}^{i + 1} - {P}^{i} ) = 0 \qquad ( 20 )$$

$${V}^{i + 1} - {{V}^{i} ( \frac{dv}{dQ} )}^{i} ( {Q}^{i + 1} - {Q}^{i} ) = 0 \qquad ( 21 )$$

$${pf}^{i} \geq {pf}^{min , lag , i} \qquad ( 22 )$$

$${pf}^{i} \geq {pf}^{min , lead , i} \qquad ( 23 )$$

$${I}^{i} \leq {I}^{max , i} \qquad ( 24 )$$

The V^{min,i} and V^{max,i} can denote the minimum and maximum voltage limits, respectively, at a particular location (e.g., for the residential area associated with the load or PV). The Vⁱ can denote the measured voltage. The

$${( \frac{dV}{dP} )}^{i}$$

can denote the location-specific, time-dependent change in voltage due to a change in real power (e.g., positive and negative). The

$${( \frac{dV}{dQ} )}^{i}$$

can denote the equivalent term for reactive power. The pfⁱ can denote the measured power-factor. The pf^{min,X,i} can denote the power factor lower bound (e.g., X=lag, lead denotes a lagging or leading power factor). The Iⁱ and I^{max,i} can denote the measured and max- allowable current, respectively. The formulas (19)-(21) can constrain the DER operations to maintain specified or predefined voltage bounds through the site-specific characterization of the voltage sensitivity to real power and reactive power. The formulas (22)-(23) can prevent the power factor from dropping below utility-defined limits. The formula (24) can limit the total current drawn (from the utility grid 100) or sent (to the utility grid 100) to prevent overloading of lines or voltage transformers, among other grid components. By using formulas (19)-(24), at least the local power quality constraints (e.g., voltage, current, or power-factor) can be accounted for in the optimization (e.g., at least in the first stage for generating the trajectories or scenarios). It should be noted that the local power quality constraints are provided as an example, and other types of constraints, parameters, or bounds may be accounted for (or considered) for the optimization. The one or more formulas can be utilized by one or more components of the DER control device 201, such as at least the trajectory manager 208 or action manager 212.

In some cases, the voltage sensitivity to real power and reactive power relationships

$$( {( \frac{dV}{dP} )}^{i} , {( \frac{dV}{dQ} )}^{i} )$$

can be updated periodically or at operator-defined frequency to maintain accuracy. It should be noted that these relationships may be time-varying, which can be forecasted using at least one suitable forecasting technique, which may involve techniques or methods for the determination of the relationships (instead of a direct measurement). Example inputs for the prediction can include at least one of but not limited to the time-of-day, day-of-week, temperature, and historical voltage at that time-of-day, day-of-week, or temperature. Example methods or models of utilizing the inputs to predict the relationships can include at least one of but not limited to decision trees, regressors (e.g., regression techniques), or neural networks. Any types of models discussed herein can be trained to predict or forecast values in subsequent time intervals of a given time series of variables. For example, the decision tree can map combinations of conditions (e.g., intervals, thresholds, or ranges) of the input variables to the outputs according to the training conducted to perform the prediction. In another example, the regressors can model the algebraic relationships between the inputs and outputs. In further examples, the neural networks can learn the relationships between the inputs and outputs and embed the relationships into model weights. The model manager 206 can train the model using any suitable training techniques and training data. The model manager 206 can iteratively train the model using feedback information from incoming data, e.g., current data or observed data, for comparison with the predictions.

For purposes of providing examples herein, the input (over the specified time horizon and resolution, e.g., the next 24 hours at a 15-minute resolution) for the first stage optimization can include but is not limited to at least one of multiple-scenario PV-forecasts, multiple-scenario load-forecasts, electricity tariff rates, initial SoC of energy storage, or initial SoC of EV(s). The output (e.g., over the specified time horizon and resolution) from the first stage optimization can include but is not limited to at least one of optimized EV schedule, optimized ES schedule, or PV-curtailment schedule. The (operational) constraints (over the specified time horizon and resolution) can include but are not limited to at least one of the discharging rate, the charging rate, the SoC limits, or the target SoC for EV(s), the discharging rate, the charging rate, or the SoC limits for the ES, minimize curtailment or maximum generation rate for the PV, and power-import limits, power-export limits, or power quality constraints (e.g., local-voltage boundaries) for the utility grid 100.

Subsequent to the first stage optimization, the data processing system 150 can perform a second stage optimization (e.g., short-time horizon, high-temporal-resolution optimization, or short-term optimization), at operation 304. The second stage, short-time-horizon, high-temporal-resolution optimization can be used for near-term, relatively fast DER-control in the presence of frequently changing electrical conditions at the grid edge, e.g., real-time changes. The optimization problem for the second stage optimization can be solved in a similar manner or using one or more similar techniques as the first stage with certain differences.

For example, in the second stage optimization, the trajectory manager 208 can perform at least one (short-term optimization) forecast for the load and PV over the short-term horizon at a predefined high-temporal resolution. The short-term forecasting can have a duration that is less than the duration of the long-term forecast, such as 24-hour forecast (e.g., a first duration) for the first stage optimization and 5-minutes (e.g., a second duration) forecast for the second stage optimization.

In another example, the “soft bounds” (e.g., boundaries) generated in the first stage can be added or included to the objective function (e.g., optimization function) of the second stage optimization to penalize second stage schedules that deviate from the selected or chosen first stage boundaries. Penalizing the second stage schedules can involve reducing, or in some cases, preventing certain DER scheduling in the second stage optimization that deviates from one or more boundaries from the first stage optimization. In further examples, the median values of

$$\frac{dV}{dP} and \frac{dV}{dQ}$$

(e.g., formulas (20)-(21)) from the first stage timespan aligning with the second stage can be used, e.g., the fluctuation of the median values of

$$\frac{dV}{dP} and \frac{dV}{dQ}$$

from the first stage can be relatively small over the second stage horizon.

The trajectory manager 208 can execute one or more features, functionalities, or operations to generate one or more short-term trajectories similar to the generation of the (long-term or long horizon) trajectories in the first stage optimization. As discussed herein, the trajectory manager 208 can generate at least one short-term trajectory based on or according to a condition of electrical characteristics measured at a current time and the long-time horizon trajectories (or scenarios), e.g., the (long-term) trajectories used as boundaries or constraints for generating the short-term trajectory. For example, the data collector 204 can collect or measure electrical data or characteristics of electricity at the site (e.g., in real-time). The condition detector 210 can detect the condition related to characteristics of electricity at the site according to the measured electricity data. The condition related to the electricity characteristics can include or refer to at least one of the state of electrical consumption (e.g., total electrical load), status of stored electricity in the one or more local distributed energy sources (e.g., power storages or supplies), electricity generation rate of the PV, changes in the electricity consumption, patterns or signatures of the electricity, etc. The condition of the electrical characteristics can be affected by the weather condition.

In response to detecting the condition, the trajectory manager 208 can generate at least one short-term trajectory or forecast using at least one model, at operation 304. The short-term forecasting or trajectory can include a predefined time horizon at predefined sampling resolution, such as 5 minutes of forecasting at 15-seconds resolution. The short-term trajectory can include other short-term time horizon (e.g., second duration) that is relatively shorter than the long-term time horizon (e.g., first duration), such as 10 minutes, 15 minutes, or 20 minutes of forecasting the load (e.g., power consumption) or PV (e.g., power generation) at the site.

The objective function of the second stage can be described in conjunction with at least formula (25) provided below for reference. The objective function of formula (25) can be applied to the short-term trajectory or forecast to create optimal dispatch of DER, e.g., EV charging, battery maintenance or discharging, or utilization of generated solar power from the PV to satisfy or meet the electricity demand. Applying the objective function can refer to using the objective function to compute a decision for the short-term forecast, for example.

$$\{ {\sum }_{i ∈ H} ( {ρ}_{tariff}^{i} {P}_{net}^{i} + {λ}_{PV} {P}_{PV , curtail}^{i} + {λ}_{reg} \vert {P}_{net}^{i} \vert + {λ}_{stage 1} \frac{\vert \tilde{x} - x \vert}{\tilde{σ}} ) \} \qquad ( 25 )$$

The formula (25) can be similar to the objective function of the first stage with one additional term added, e.g., the “soft boundary” term. In this case, the optimization function (e.g., objective function) can be applied to one or more short-term trajectories generated herein based on the boundary. The soft boundary term can be used to guide the short-term actions towards the long-term schedules set in the first stage, e.g., guiding the short-term trajectories according to or based on the scenarios or long-time horizon trajectories. The soft boundary term can be weighted by λ_{stage 1} which is (empirically-)defined and may be relatively lower than the tariff rates given in ρⁱ_{tariff}, for example.

For the constraints in the second stage optimization, formula (26) can include details of the soft boundary term, provided below for reference.

$$\frac{\vert \tilde{x} - x \vert}{\tilde{σ}} = \frac{\vert \tilde{{P}_{net}} - 〈 {P}_{net} 〉 \vert}{\tilde{{σ}_{P , net}}} + \frac{\vert \tilde{{E}_{EV}} - {E}_{EV}^{- 1} \vert}{\tilde{{σ}_{E , EV}}} + \frac{\vert \tilde{{E}_{ES}} - {E}_{ES}^{- 1} \vert}{\tilde{{σ}_{E , ES}}} \qquad ( 26 )$$

The ˜ terms in the numerators can denote the scheduled values from the first stage which correspond to the current horizon (H) of the second stage. The <Pₙₑₜ> can denote the mean value of the second stage net-power over all time steps (i) within the horizon. The EV and ES terms with the −1 superscript can denote the energy values of those assets at the final time step (i=I) in the horizon. The denominator terms (σ) can weight these deltas by one standard deviation of the first stage-schedule distributions (e.g., generated from the different scenarios) at that time step. Dividing by the σ can more heavily constrain the second stage schedules to the first stage values when the distributions indicate relatively more certainty (e.g., smaller σ values).

The trajectory manager 208 can apply the objective function (e.g., based on the trajectories) to the short-term trajectory to obtain an optimal dispatch of DER. The objective function can include one or more constraints or boundaries applied to the short-term trajectory. In some cases, the constraints or boundaries for the short-term trajectory (e.g., for the second stage optimization) can include similar constraints or boundaries for the first stage optimization. For example, at operation 312, the action manager 212 can utilize the short-term trajectory to determine, select, or generate commands for at least one of EV charging, battery maintenance or discharging, or utilization of generated solar power from the PV to satisfy the electricity demand according to the short-term trajectory. The action manager 212 can select or generate a command to control the power delivery from the one or more distributed energy sources located at the site, at operation 314. The grid controller 214 can perform the control of the DER at a current time based on the selected or generated command or control from the action manager 212.

For instance, to satisfy the electricity demand can involve, the power delivery control can involve adjusting or scheduling at least one of the time to charge EV, EV charging rate (e.g., power of EV charging), amount or rate of power discharge from local energy storage or source, time of power discharge from the local energy storage (e.g., maintain a certain amount of power in the battery storage, accounting for the long-term trajectory), or discharge of electricity generated by the PV, to name a few. The action manager 212 can generate or select other commands or actions to manage the power delivery to satisfy the demand according to at least the short-term trajectory. The action manager 212 can satisfy the electricity demand while accounting for the long-term schedules or objectives, based on the short-term trajectory applied with the objective function. As such, the short-term trajectory can be utilized for optimal DER dispatch.

For purposes of providing examples herein, the input (over the specified time horizon and resolution, e.g., the next 5 minutes at a 15-seconds resolution) of the second stage optimization can include at least one of but not limited to single PV-forecast, single load-forecast, electricity tariff rates, initial SoC of ES, or initial SoC of EV(s). The output (over the specified time horizon and resolution) of the second stage optimization can include at least one of but not limited to optimized EV-schedule, optimized ES-schedule, or PV-curtailment schedule, which may be different from those outputted from the first stage optimization. The constraints (over the specified time horizon and resolution) in the second stage optimization may include similar constraints as those described in conjunction with the first stage optimization, including soft boundaries from the first stage used in the objective function, among others. Other inputs and constraints may be utilized and other outputs may be generated or provided from the second stage optimization, not limited to those discussed herein.

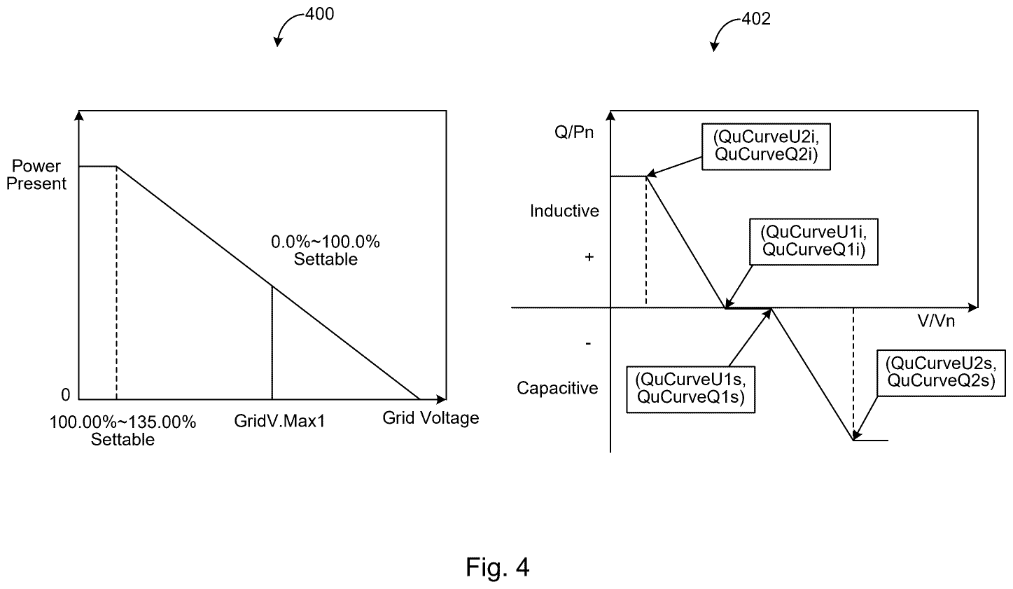

In various cases, it should be noted that controlling DERs participating in the optimization, such as by the action manager 212 or the grid controller 214, may be more complicated than sending desired schedules or ad-hoc requests to the DERs in the form of setpoint changes (e.g., more complex than sending a signal indicating “reduce the inverter's output power by 5%”, such as involving other operations or information). For instance, the grid controller 214 can perform means of modulating the output power of the PV inverter (P_{PV}), or means of affecting the local voltage (e.g., for some inverter types) via changes to a shape-constrained curve. For example, FIG. 4 illustrates example graphs 400-402 of PV inverter control, in accordance with an implementation. In some configurations, modulating the output power of the PV inverter can be performed by adjusting or changing the “Volt-Watt” curve 400. In some configurations, affecting the local voltage can be performed by adjusting the Volt-Watt curve 400 or “Volt-VAR” curve 402. In such cases, the desired schedule or control action for a PV inverter can be translated to the settings using at least one suitable conversion or translation technique (e.g., by the data processing system 150 or other components within the utility grid 100) for at least one of the curves to yield the desired functional outcome which the optimization requests.

Example scenarios involving control-curve modifications can be provided as follows. For example, as a first example, the optimization may involve a reduction of the output power of the PV (Pⁱ_{PV,curtail}). The predicted voltage-distribution during the relevant timespan can be used to define the power-derating start-point (e.g., shown in the dashed line in graph or curve 400) and slope, which can be the two configurable settings of the Volt-Watt curve 400. In some cases, the voltage distribution can be determined in real-time (e.g., alleviating the need for prediction), for instance, if the feedback loop between voltage measurement and updating the inverter control yielding a change in the output power of the inverter is sufficient in speed (e.g., lower than a predefined time threshold) for the desired operation, predefined by the operator or administrator of the system. In such cases, the action manager 212 can translate the short-term trajectory to a control setting (e.g., configurable setting) to generate one or more commands, such as to adjust the PV output power in this case. The action manager 212 can provide the generated command(s) to the grid controller 214 to control the PV output power according to the settings.

In another example, e.g., a second example, the optimization may involve a modification (e.g., by at least the grid controller 214) of the local voltage due to a voltage violation (e.g., formula (19)). The predicted (or measured)

$${( \frac{dV}{dP} )}^{i}$$

relationship can be used to define the settings of the Volt-Watt curve 400, or the

$${( \frac{dV}{dQ} )}^{i}$$

relationship can be used to define the settings of the Volt-VAR curve 402 (e.g., the four vertices labeled in curve 402). The relationships discussed hereinabove can define the amount of real power or reactive power modulation to change the local voltage by a desired amount. According to the above, margins of error, real-time feedback, or control update can be performed to effectively maintain the system within the local power quality bounds. As discussed herein, the action manager 212 can determine, select, or generate one or more actions or commands based on at least the one or more trajectories, short-term trajectories, bounds, or constraints, among other factors output or identified by the one or more components (e.g., trajectory manager 208 or condition detector 210) of the DER control device 201. The grid controller 214 can perform or execute the one or more actions or commands from the action manager 212 to control the power delivery from the distributed energy source(s) at the site. In some cases, the action manager 212 may send a command or instruction to other devices within the system 200 or the utility grid 100 for execution, for instance, to manage electrical distribution or generation from the utility grid 100.

In various aspects, the systems and methods of the technical solution discussed herein can address the uncertainties in forecasts and include such forecasts in the optimization formulation, formulate the optimization to enable computation on relatively low-computational-power devices at the grid edge, account for the effects on local grid voltage and current flow in the optimization, or process and store all data locally, thereby minimizing and reducing data transmission costs and preserving privacy.

In some configurations, the systems and methods may not utilize scenario generation that accounts for uncertainties in the forecasts. In some configurations, the data from the DER control device 201, metering device 118, or other edge devices may be sent to the data processing system 150, the cloud, or a remote computing device for processing. In such cases, the DER commands can be generated by and sent from a grid manager 232 of the data processing system 150 to the DER control device 201 or other edge devices, e.g., as a response message or signal. In some cases, the DER control device 201 can send a command or instructions to the data processing system 150. The grid manager 232 of the data processing system 150 can execute the command, e.g., to control electricity generation or electricity distribution to the site or other sites. Controlling the electricity generation can involve increasing or decreasing electricity generation by the utility grid 100 to satisfy electricity demands from the sites. Controlling the electricity distribution can involve managing the distribution of electricity by allocating more or less electrical resources to different sites depending on their respective power demands.

The data repository 216 can be referred to as a data storage, database, memory device, etc. The data repository 216 can include at least a utility grid data storage 218, a parameter data storage 220, a training data storage 222, a model storage 224, a trajectory data storage 226, a condition data storage 228, and an action storage 230. The data repository 216 can include other types of storage to store information for generating forecasting or scenarios or performing DER dispatch. In some cases, information stored in the data repository 216 can be uploaded to or synced with the data repository 234 of the data processing system 150, among other remote devices, or downloaded to the data repository 216 for processing. For instance, the data repository 234 may include one or more information uploaded from the DER control device 201 or other metering devices 118, such as but not limited to measurement data, models, or trajectory data. In some other cases, the information stored in the data repository 216 may be local to DER control device 201 at the site. The data repository 216 can be accessed by one or more components of the DER control device 201, or at least one external or remote device, such as other metering devices 118 within the utility grid 100, the data processing system 150, etc., authorized to access the data repository 216.

The utility grid data storage 218 can include, store, or maintain information related to the utility grid 100 obtained, measured, or detected by the DER control device 201 (e.g., interface 202 or data collector 204). For example, the utility grid data storage 218 can store electrical data received or measured by the data collector 204, such as time series of electrical data, electrical waveform data, normalized or processed data, etc. The utility grid data storage 218 can store timestamps of when the data are logged or stored in the data repository 216. In some cases, the utility grid data storage 218 can include the identifier of the DER control device 201 (or metering device 118 at the site), for instance, to be provided to the data processing system 150 or a server during data transmission. In some other cases, the utility grid data storage 218 can include the geographical location of the DER control device 201 (or the metering device 118).

The parameter data storage 220 can include, store, or maintain various parameters or variables utilized by the one or more components of the DER control device 201. For example, the parameter data storage 220 can store the constraints, boundaries, or variables utilized by at least the trajectory manager 208 or the action manager 212. Certain constraints or boundaries may be received by the data processing system 150. In some cases, the DER control device 201 may download or obtain one or more constraints or boundaries from the data processing system 150. The variables may be one or more variables used in one or more formulas, for example.

The training data storage 222 can include, store, or maintain training data for training the model. The training data storage 222 can be accessed by the one or more components of the DER control device 201, such as by the model manager 206 for updating or training the models or by the trajectory manager 208 for generating one or more trajectories, e.g., long-time horizon or short-time horizon trajectories. The training data can include historical electrical data, historical weather data, various metrics, labels, ground truth, validation data set, test data set, or other information for training or updating the models. The training data stored in the training data storage 222 can be updated by the DER control device 201, the data processing system 150 or other remote devices. The training data stored in the training data storage 222 may be updated with additional training data from other metering devices 118 or with current measurements for comparison with the predictions or forecast.

The model storage 224 can include, store, or maintain at least one model generated, trained, or managed by the model manager 206. For example, the model storage 224 can store a model generated by the model manager 206. The model storage 224 can be accessed by the model manager 206 to train or update the model. In some cases, the model storage 224 can delete at least one model based on a command from the DER control device 201, the data processing system 150, or the model manager 206. The model storage 224 can be accessed by the trajectory manager 208 for forecasting or generating trajectories (e.g., short-term or long-term trajectories), for instance, utilized in the multi-stage optimization process. The model storage 224 can store one or more models generated or trained by the DER control device 201, the data processing system 150, or other metering devices 118. The model storage 224 can store other information or data related to the model, such as the configuration, different types of models, types of machine learning techniques used to train individual models, model versions, last updated date, etc.

The trajectory data storage 226 can include, store, or maintain a plurality of trajectories generated for the multi-stage optimization process. The trajectory data storage 226 can be accessed by one or more components of the DER control device 201, such as the trajectory manager 208 or action manager 212. The trajectory data storage 226 can store the (long-term) trajectories generated for long-time horizon, e.g., in the first stage optimization. The trajectories can include or correspond to the long-term forecasts or scenarios, in the first stage. The trajectory data storage 226 can store short-term trajectories guided by or generated based on at least the long-term trajectories. The trajectory information may include at least one of but not limited to timestamps, associated weather condition, projected or forecasted load, forecasted PV (e.g., power generation), sampling resolution of the trajectory, time horizon of the trajectory, or DER settings or configurations for one or more timestamps, to name a few. The trajectory data storage 226 can store other information related to the trajectories.

The condition data storage 228 can include, store, or maintain conditions related to characteristics of electricity. The conditions can be measured or recorded by one or more components of the DER control device 201, such as the data collector 204. In some cases, the condition data storage 228 may share certain information with the utility grid data storage 218. For example, the conditions of or related to electrical characteristics can include at least one of but not limited to the total electrical consumption at the site, EV charging rate, electrical output from the PV, or discharging rate from the distributed energy sources at the site. The condition data storage 228 can be accessed by at least the trajectory manager 208, for instance, to use the conditions of electrical characteristics for generating the one or more short-term trajectories.

The action storage 230 can include, store, or maintain various actions selectable by the action manager 212 or executable by the grid controller 214. The actions can include or correspond to executable codes, instructions, or commands for execution by at least the grid controller 214. The actions can be predetermined by the operator or the administrator of the utility grid 100 or the user at the site. In some cases, one or more actions or commands can be generated by the action manager 212 for controlling power delivery from at least one energy source.

In some cases, the DER control device 201 may receive the predefined actions from the data processing system 150 or a grid device (e.g., administrator device) to store locally in the action storage 230. The action storage 230 can store new or updated actions upon receiving the actions. The action storage 230 can remove at least one predefined action responsive to a command from the data processing system 150 or the grid device. In some cases, the action storage 230 can store similar types of actions as those stored in other metering devices 118 (e.g., the actions synched to other systems or devices). The action can refer to, include, or otherwise be related to scheduling of DER utilization or dispatching a DER. For example, the action can include one or more commands for scheduling EV charging, adjusting EV charging rate, scheduling discharging time from local energy sources (e.g., local battery or power supply), discharging rate from the local energy sources or PV, or scheduling discharging rate from the site to at least one other site or utility grid 100 (e.g., sell electricity generated by the PV or other electrical generation devices at the site), among others. The action may include commands for controlling grid operation, such as grid power generation or electricity distribution to one or more sites. In some cases, the action may include providing notification to other devices, such as the data processing system 150, the client device at the site, or the grid device. The action can include other types of actions related to power delivery for the site or DER dispatch.

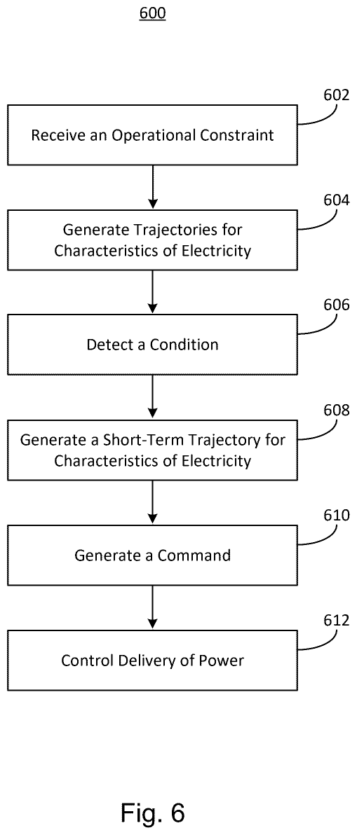

FIG. 6 is an example flow diagram of a method 600 for dispatching DER using edge devices. The example method 600 can be executed, performed, or otherwise carried out by one or more components of the utility grid 100 (e.g., computing device, metering devices 118, data processing system 150, etc.), the system 200 (e.g., DER control device 201, data processing system 150, etc.), or computing device 700, etc. Although the DER control device is described herein to execute or perform the method 600, other metering devices or the data processing system can perform similar features or functionalities as the DER control device to perform the method 600. The method 600 can include receiving an operational constraint, at ACT 602. At ACT 604, the method 600 can include generating trajectories for characteristics of electricity. At ACT 606, the method 600 can include detecting a condition. At ACT 608, the method 600 can include generating a short-term trajectory for characteristics of electricity. At ACT 610, the method 600 can include generating a command. At ACT 612, the method 600 can include controlling delivery of power.

Still referring to FIG. 6 in further detail, at ACT 602, a DER control device (e.g., metering device) located at a site can receive an operational constraint. The DER control device can be connected to the utility grid (e.g., electricity distribution grid). The DER control device can receive the operational constraint from a data processing system remote from the DER control device. The operational constraint can include but is not limited to EV discharging rate, EV charging rate, EV SoC limits, EV target SoC, ES discharging rate, ES charging rate, ES SoC limit, PV minimize curtailment, PV max generation rate, grid power-import limits, grid power-export limits, or power-quality constraints. The operational constraint can be a part of one or more formulas discussed herein. The operational constraint can be used, at least in part, to generate a plurality of trajectories.

At ACT 604, the DER control device can generate a plurality of trajectories for characteristics of electricity at the site. The DER control device can generate the trajectories for a time interval. The DER control device can generate the trajectories based on the operational constraint and bounds for local power quality at the site. The trajectories can include or correspond to forecasts over the time interval (e.g., long-time horizon) or scenarios of the forecasts. The DER control device can generate the forecasts which satisfy the operational constraint and bounds for local power quality. The bounds for local power quality can be described in conjunction with at least one of but not limited to formulas (19)-(24). The generated forecasts and scenarios can satisfy the configured constraints and bounds.

In some cases, the DER control device can use a stochastic programming function (e.g., stochastic optimization) to generate the trajectories. The stochastic programming function can be configured to account for uncertainty related to load and photovoltaic generation estimates. For example, the stochastic programming function can involve generating a set of scenarios (e.g., varying forecasts) and creating an optimal schedule for each scenario, thereby generating a distribution of optimal schedules. The various scenarios can refer to or include various forecasts over the time interval (e.g., the long-time horizon), accounting for varying load, PV generation, weather conditions, etc., such as based on historical data at the site.

The DER control device can use the trajectories for optimal EV scheduling considering the demand and PV uncertainties for the time interval. For instance, the DER control device can schedule at least EV charging or discharging, to satisfy at least one of the trajectories including the objective function (e.g., of the first stage optimization), constraints, or bounds. The DER control device can apply an objective function to the trajectories for creating optimal schedules for DER dispatch. The generation of trajectories and the creation of the optimal DER schedule can involve a plurality of formulas discussed herein.

In some configurations, the DER control device can generate the trajectories using at least one model or machine learning techniques. For example, the DER control device can generate the trajectories using a regression technique, e.g., model algebraic relationships between the inputs and outputs. In another example, the DER control device can generate the trajectories using a decision tree, e.g., map combinations of conditions (e.g., intervals, thresholds, or ranges) of the input variables to the outputs according to the training conducted to perform the prediction. In further examples, the DER control device can generate the trajectories using a neural network, e.g., learn relationships between the inputs and outputs and embed the relationships into model weights. The DER control device can utilize other types of models, not limited to those discussed herein, to generate the trajectories (e.g., perform prediction or forecasting). The models can be trained using respective training techniques or procedures to perform the intended tasks, such as generate predictions or forecasts.

At ACT 606, the DER control device can detect a condition related to the characteristics of electricity at the site. The DER control device can detect the condition in real-time during the time interval. Detecting the condition of electrical characteristics can involve measuring the electricity at the site or obtaining other information relevant to the generation or consumption of electricity. For example, during the time interval, the DER control device can measure at least one of electrical load (e.g., total power consumed at the site), PV generation, weather condition, EV charging or discharging status, charge or discharge status of the one or more distributed energy sources (e.g., battery or power supply) at the site, etc. The electrical information associated with the site can be the condition related to the characteristics of electricity. The DER control device can utilize the condition discussed herein to generate at least one short-term trajectory, for example.

At ACT 608, the DER control device can generate at least one short-term trajectory for characteristics of electricity. The short-term trajectory (or short-term optimization forecast) can have a duration (e.g., second duration) that is less than a duration (e.g., first duration) of the generated trajectories. For example, based on the condition of electrical characteristics measured in real-time, e.g., the current state or status of electrical consumption and generation, the DER control device can determine to execute a multi-stage optimization process to control the delivery of power from the one or more distributed energy sources. The multi-stage optimization process can include at least a first stage and a second stage. The first stage can include the generation of the plurality of trajectories for the time interval having the first duration. The second stage can include the generation of one or more short-term trajectories based on the condition. The short-term trajectory can have the second duration shorter than the first duration. For instance, in certain scenarios, the first duration (corresponding to the first interval) can be 24 hours and the second duration can be 5 minutes.

The short-term trajectory can provide relatively high accuracy responsive to real-time changes in electricity at the site. With the multi-stage optimization, long-term asset planning (e.g., from the long-time horizon trajectories) and accurate prediction using high-temporal resolution (e.g., from the short-term trajectory) can be achieved. The long-term trajectories (or boundaries and constraints associated with the long-term trajectories) can be used, at least in part, as boundaries or constraints for generating the short-term trajectories. As such, the DER control device can generate the short-term trajectory based on the condition of electrical characteristics and the (long-time horizon) trajectories.

The DER control device can generate at least one short-term trajectory (e.g., short-term forecast of load and PV generation) based on the condition. For instance, the DER control device can correlate the current condition of electrical characteristics with the historical data to predict electrical load or PV generation in the next time duration based on various factors discussed herein. The DER control device can generate the short-term trajectory to satisfy at least one of: the objective function (e.g., of the second stage optimization), the constraints, or the bounds.

The DER control device can apply an optimization function (e.g., to maximize or minimize an objective function) to the short-term trajectory. The DER control device can apply the optimization function to maintain the local power quality at the site to generate the one or more commands to control the delivery of power from the one or more distributed energy sources at the site. For example, the boundaries generated in the first stage optimization can be added or included to the optimization function of the second stage optimization to penalize second stage schedules that deviate from the selected or chosen first stage boundaries. Penalizing the second stage schedules can involve reducing, or in some cases preventing certain DER scheduling in the second stage optimization that deviates from one or more boundaries from the first stage optimization (e.g., boundaries associated with the trajectories). In response to applying the optimization, the DER control device can obtain optimal dispatch of DER, e.g., optimal EV charge or discharge schedule or rate, battery charge or discharge schedule or rate, or PV generation rate or discharge of generated power from PV, among others, to satisfy the demand determined based on the short-term trajectory.

At ACT 610, the DER control device can generate a command to control the delivery of power from the one or more distributed energy sources. The DER control device can generate the command based on short-term optimization forecast (e.g., short-term trajectory). For example, the DER control device can generate one or more commands to control the DER to satisfy the demands (e.g., load or PV generation), e.g., control the delivery of power from the one or more distributed energy sources in accordance with the short-term trajectory.

In some cases, the DER control device can generate at least one boundary based on the plurality of trajectories. The boundary may be the soft boundary, for example. In such cases, the DER control device can generate one or more commands to control the delivery of power from the one or more distributed energy sources via or by applying an optimization function (e.g., objective function) to the plurality of short-term trajectories based on the boundary (e.g., added or included as part of the objective function). The boundary can be added to the optimization function as part of the second stage optimization in the multi-stage optimization process.

At ACT 612, the DER control device can control delivery of power from one or more distributed energy sources located at the site during the time interval. The DER control device can control the power delivery in real-time, responsive to the detection of the condition, based on i) one or more of the plurality of trajectories, ii) the detected condition, and iii) the bounds for local power quality at the site. The one or more trajectories can be utilized as a guide or constraint for short-term trajectory generation or controlling the power delivery to satisfy the long-term asset planning, for example. The detected condition can be utilized to generate the short-term trajectory, which can be utilized for determining demands at the site to generate commands for the power delivery control. In some cases, the detected condition can be utilized to compare with the forecast or scenarios, e.g., generated in the first stage optimization, to adjust, update, or maintain DER scheduling according to at least one of the trajectories over the time interval having the first duration.

In some cases, the DER control device can control the delivery of power in accordance with the plurality of trajectories based on a rolling-horizon including a plurality of time intervals within the time interval. For example, the DER control device can integrate stochastic programming with rolling-horizon (e.g., rolling time window) control in a multi-stage optimization process. The rolling-horizon control can plan multiple decisions, where each decision can be executed in a respective time period, such as a first decision in a current time, a second decision in a subsequent time, etc. The decision can refer to at least the DER operation to be performed or the schedule of the DER operation. In some cases, an optimization problem can be solved at each time step to determine one or more actions over a specified time horizon (e.g., of the rolling-horizon) and resolution. Each time step can correspond to or be associated with a respective time horizon, such as long-time horizon or short-time horizon. The decision for a current time can be executed in response to the planning of the decisions, and the planning process can be repeated at the next time step, solving a subsequent (e.g., new) optimization problem with the time horizon shifted one step forward. Therefore, the DER control device can control the power delivery based on the rolling-horizon and in accordance with the trajectories to satisfy the long-term asset planning, among other constraints or bounds, for example.

Controlling the delivery of power can include scheduling DER to charge or discharge from the local distribution energy source(s), or adjust the charge rate or discharge rate. Scheduling DER can refer to scheduling or planning to deliver power to or from the electrical device, such as the charger, battery, or PV at the scheduled time. For example, based on at least one of the short-term trajectory (e.g., load and PV generation), constraints, or bounds, if the DER control device determines that the electricity demand is excessive (e.g., above a threshold), the DER control device can schedule (or re-schedule) at least one of EV charger, distributed energy source(s), or PV to satisfy the demand, e.g., reduce EV charge rate or reschedule EV charging time to reduce electrical consumption, increase discharge rate or schedule output from the distributed energy source(s) to increase electricity supply to the site during the excessive electricity demand, or output the power generated from the PV during the time interval.

Controlling the delivery of power can include or involve adjusting the settings or configurations of the DER. For example, the DER control device can translate the short-term trajectory to a control setting to generate the one or more commands. The short-term trajectory can indicate the load and PV generation forecast, which can be translated to an amount of electricity demanded at the site or an amount of electricity to be discharged from the site (e.g., excess electricity generated). The DER control device can control the power delivery based on other factors in addition to the trajectories, the short-term trajectory, bounds, or constraints, among others. The DER control device can perform other operations to control the power delivery, such as to satisfy the electricity demand in accordance with the short-term trajectory, not limited to those discussed herein.

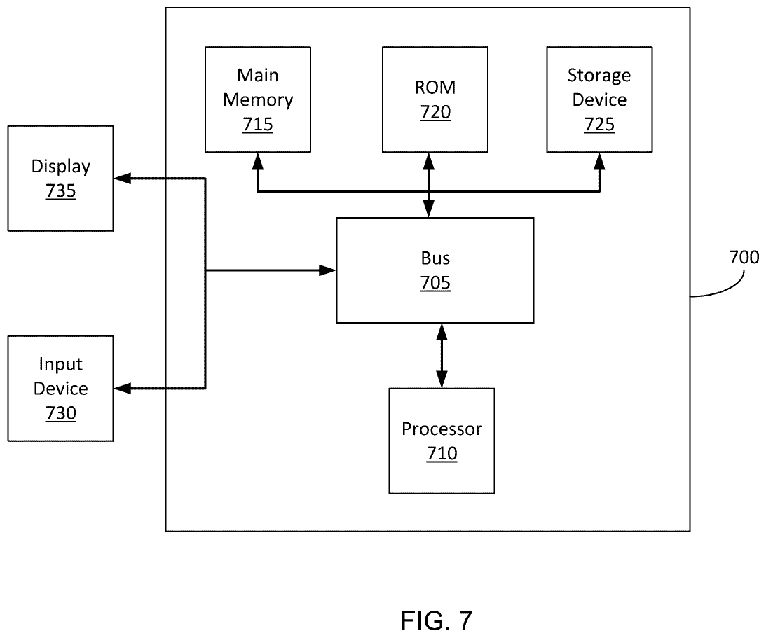

FIG. 7 is a block diagram of an example computer system 700. The computer system or computing device 700 can include or be used to implement the DER control device 201, or its components. The computing system 700 includes at least one bus 705 or other communication components for communicating information and at least one processor 710 or processing circuit coupled to the bus 705 for processing information. The computing system 700 can also include one or more processors 710 or processing circuits coupled to the bus for processing information. The computing system 700 also includes at least one main memory 715, such as a random access memory (RAM) or other dynamic storage devices, coupled to the bus 705 for storing information, and instructions to be executed by the processor 710. The main memory 715 can also be used for storing position information, utility grid data, command instructions, device status information, environmental information within or external to the utility grid, information on characteristics of electricity, or other information during execution of instructions by the processor 710. The computing system 700 may further include at least one read only memory (ROM) 720 or other static storage device coupled to the bus 705 for storing static information and instructions for the processor 710. A storage device 725, such as a solid state device, magnetic disk or optical disk, can be coupled to the bus 705 to persistently store information and instructions.

The computing system 700 may be coupled via the bus 705 to a display 735, such as a liquid crystal display, or active matrix display, for displaying information to a user such as an administrator of the data processing system or the utility grid. An input device 730, such as a keyboard or voice interface may be coupled to the bus 705 for communicating information and commands to the processor 710. The input device 730 can include a touch screen display 735. The input device 730 can also include a cursor control, such as a mouse, a trackball, or cursor direction keys, for communicating direction information and command selections to the processor 710 and for controlling cursor movement on the display 735. The display 735 can be part of the DER control device 201, the data processing system 150, or other components of at least FIGS. 1 and 2.

The processes, systems, and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors in a multi-processing arrangement may also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter including the operations described in this specification can be implemented in other types of digital electronic circuitry, or in computer software, firmware, or hardware, including the structures disclosed in this specification and their structural equivalents, or in combinations of one or more of them.

### Further Examples

The following examples pertain to further embodiments, from which numerous permutations and configurations will be apparent.

Example 1 includes a system, comprising: a DER control device located at a site connected with an electricity distribution grid, the DER control device comprising one or more processors, coupled with memory, to: receive, from a data processing system of the electricity distribution grid that is remote from the DER control device located at the site, an operational constraint; generate, for a time interval, a plurality of trajectories for characteristics of electricity at the site based on the operational constraint and bounds for local power quality at the site; detect, in real-time during the time interval, a condition related to the characteristics of electricity at the site; and control, in real-time and responsive to the detection, during the time interval, delivery of power from one or more distributed energy sources located at the site based on i) one or more of the plurality of trajectories, ii) the detected condition, and iii) the bounds for local power quality at the site.

Example 2 includes the subject matter of Example 1, wherein the DER control device is further configured to: control the delivery of power in accordance with the plurality of trajectories based on a rolling-horizon comprising a plurality of time intervals within the time interval.

Example 3 includes the subject matter of any of Examples 1 and 2, wherein the DER control device is further configured to: generate the plurality of trajectories for the time interval having a first duration; and generate a command to control the delivery of power from the one or more distributed energy sources based on a short-term optimization forecast having a second duration that is less than the first duration.

Example 4 includes the subject matter of any of Examples 1 through 3, wherein the DER control device is further configured to: use a stochastic programming function to generate the plurality of trajectories, wherein the stochastic programming function is configured to account for uncertainty related to load and photovoltaic generation estimates.

Example 5 includes the subject matter of any of Examples 1 through 4, wherein the DER control device is further configured to: generate the plurality of trajectories using a regression technique.

Example 6 includes the subject matter of any of Examples 1 through 5, wherein the DER control device is further configured to: generate the plurality of trajectories using a decision tree.

Example 7 includes the subject matter of any of Examples 1 through 6, wherein the DER control device is further configured to: generate the plurality of trajectories using a neural network.

Example 8 includes the subject matter of any of Examples 1 through 7, wherein the DER control device is further configured to: generate a short-term trajectory based on the condition and the plurality of trajectories; and generate one or more commands to control the delivery of power from the one or more distributed energy sources in accordance with the short-term trajectory.

Example 9 includes the subject matter of any of Examples 1 through 8, wherein the DER control device is further configured to: generate a boundary based on the plurality of trajectories; generate a plurality of short-term trajectories based on the condition and the plurality of trajectories; and generate, via an optimization function applied to the plurality of short-term trajectories based on the boundary, one or more commands to control the delivery of power from the one or more distributed energy sources.

Example 10 includes the subject matter of any of Examples 1 through 9, wherein the DER control device is further configured to: determine, based on the condition, to execute a multi-stage optimization process to control the delivery of power from the one or more distributed energy sources, wherein a first stage of the multi-stage optimization process comprises the generation of the plurality of trajectories for the time interval, and a second stage of the multi-stage optimization process comprises the generation of the plurality of short-term trajectories based on the condition.

Example 11 includes the subject matter of any of Examples 1 through 10, wherein the DER control device is further configured to: apply the optimization function to maintain the local power quality at the site to generate the one or more commands to control the delivery of power from the one or more distributed energy sources.

Example 12 includes the subject matter of any of Examples 1 through 11, wherein the DER control device is further configured to: translate the short-term trajectory to a control setting to generate the one or more commands.

Example 13 includes a method, comprising: receiving, by a DER control device, from a data processing system of an electricity distribution grid that is remote from the DER control device located at a site, an operational constraint, wherein the DER control device is located at the site connected with the electricity distribution grid; generating, by the DER control device, for a time interval, a plurality of trajectories for characteristics of electricity at the site based on the operational constraint and bounds for local power quality at the site; detecting, by the DER control device, in real-time during the time interval, a condition related to the characteristics of electricity at the site; and controlling, by the DER control device, in real-time and responsive to the detection, during the time interval, delivery of power from one or more distributed energy sources located at the site based on i) one or more of the plurality of trajectories, ii) the detected condition, and iii) the bounds for local power quality at the site.

Example 14 includes the subject matter of Example 13, comprising: controlling, by the DER control device, the delivery of power in accordance with the plurality of trajectories based on a rolling-horizon comprising a plurality of time intervals within the time interval.

Example 15 includes the subject matter of Examples 13 and 14, comprising: generating, by the DER control device, the plurality of trajectories for the time interval having a first duration; and generating, by the DER control device, a command to control the delivery of power from the one or more distributed energy sources based on a short-term optimization forecast having a second duration that is less than the first duration.

Example 16 includes the subject matter of Examples 13 through 15, comprising: using, by the DER control device, a stochastic programming function to generate the plurality of trajectories, wherein the stochastic programming function is configured to account for uncertainty related to load and photovoltaic generation estimates.

Example 17 includes the subject matter of Examples 13 through 16, comprising: generating, by the DER control device, the plurality of trajectories using at least one of a regression technique, a decision tree, or a neural network.

Example 18 includes the subject matter of Examples 13 through 17, comprising: generating, by the DER control device, a short-term trajectory based on the condition and the plurality of trajectories; and generating, by the DER control device, one or more commands to control the delivery of power from the one or more distributed energy sources in accordance with the short-term trajectory.

Example 19 includes the subject matter of Examples 13 through 18, comprising: generating, by the DER control device, a boundary based on the plurality of trajectories; generating, by the DER control device, a plurality of short-term trajectories based on the condition and the plurality of trajectories; and generating, by the DER control device, via an optimization function applied to the plurality of short-term trajectories based on the boundary, one or more commands to control the delivery of power from the one or more distributed energy sources.

Example 20 includes a non-transitory computer-readable medium storing processor-executable instructions that, when executed by one or more processors, cause the one or more processors to: receive, from a data processing system of an electricity distribution grid that is remote from a DER control device located at a site, an operational constraint, wherein the site connected with the electricity distribution grid managed by the data processing system; generate, for a time interval, a plurality of trajectories for characteristics of electricity at the site based on the operational constraint and bounds for local power quality at the site; detect, in real-time during the time interval, a condition related to the characteristics of electricity at the site; and control, in real-time and responsive to the detection, during the time interval, delivery of power from one or more distributed energy sources located at the site based on i) one or more of the plurality of trajectories, ii) the detected condition, and iii) the bounds for local power quality at the site.

Some of the descriptions herein emphasize the structural independence of the aspects of the system components (e.g., arbitration component) and illustrate one grouping of operations and responsibilities of these system components. Other groupings that execute similar overall operations are understood to be within the scope of the present application. Modules can be implemented in hardware or as computer instructions on a non-transient computer-readable storage medium, and modules can be distributed across various hardware-or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a Compact Disk Read-Only Memory (CD-ROM), a flash memory card, a Programmable Read-Only Memory (PROM), a RAM, a ROM, or a magnetic tape. In general, the computer-readable programs can be implemented in any programming language, such as List Processing (LISP), Practical Extraction and Reporting Language) PERL, C, C++, C#, Programmation en Logique (PROLOG), or in any byte code language such as JAVA. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., a field programmable gate array (FPGA) or an application specific integrated circuit (ASIC). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA or an ASIC. Devices suitable for storing computer program instructions and data can include non-volatile memory, media and memory devices, including by way of example semiconductor memory devices, e.g., Erasable Programmable Read-Only Memory (EPROM), Electrically Erasable Programmable Read-Only Memory (EEPROM), and flash memory devices; magnetic disks, e.g., internal hard disks or removable disks; magneto optical disks; and CD ROM and Digital Versatile Disk Read-Only Memory (DVD-ROM) disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including”, “comprising”, “having”, “containing”, “involving”, “characterized by”, “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation”, “some implementations”, “one implementation” or the like are not necessarily mutually exclusive and are intended to indicate that a particular feature, structure, or characteristic described in connection with the implementation may be included in at least one implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

While this specification contains many specific implementation details, these should not be construed as limitations on the scope of any inventions or of what can be claimed, but rather as descriptions of features specific to particular embodiments of particular aspects. Certain features described in this specification in the context of separate embodiments can also be implemented in combination in a single embodiment. Conversely, various features described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated in a single software product or packaged into multiple software products.

Thus, particular embodiments of the subject matter have been described. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A system, comprising:
a distributed energy resource control device located at a site connected with an electricity distribution grid, the distributed energy resource control device comprising one or more processors, coupled with memory, to:
receive, from a data processing system of the electricity distribution grid that is remote from the distributed energy resource control device located at the site, an operational constraint;
generate, for a time interval, a plurality of trajectories for characteristics of electricity at the site based on the operational constraint and bounds for local power quality at the site;
detect, in real-time during the time interval, a condition related to the characteristics of electricity at the site; and
control, in real-time and responsive to the detection, during the time interval, delivery of power from one or more distributed energy sources located at the site based on i) one or more of the plurality of trajectories, ii) the detected condition, and iii) the bounds for local power quality at the site.

2. The system of claim 1, wherein the distributed energy resource control device is further configured to:
control the delivery of power in accordance with the plurality of trajectories based on a rolling-horizon comprising a plurality of time intervals within the time interval.

3. The system of claim 1, wherein the distributed energy resource control device is further configured to:
generate the plurality of trajectories for the time interval having a first duration; and
generate a command to control the delivery of power from the one or more distributed energy sources based on a short-term optimization forecast having a second duration that is less than the first duration.

4. The system of claim 1, wherein the distributed energy resource control device is further configured to:
use a stochastic programming function to generate the plurality of trajectories, wherein the stochastic programming function is configured to account for uncertainty related to load and photovoltaic generation estimates.

5. The system of claim 1, wherein the distributed energy resource control device is further configured to:
generate the plurality of trajectories using a regression technique.

6. The system of claim 1, wherein the distributed energy resource control device is further configured to:
generate the plurality of trajectories using a decision tree.

7. The system of claim 1, wherein the distributed energy resource control device is further configured to:
generate the plurality of trajectories using a neural network.

8. The system of claim 1, wherein the distributed energy resource control device is further configured to:
generate a short-term trajectory based on the condition and the plurality of trajectories; and
generate one or more commands to control the delivery of power from the one or more distributed energy sources in accordance with the short-term trajectory.

9. The system of claim 8, wherein the distributed energy resource control device is further configured to:
generate a boundary based on the plurality of trajectories;
generate a plurality of short-term trajectories based on the condition and the plurality of trajectories; and
generate, via an optimization function applied to the plurality of short-term trajectories based on the boundary, one or more commands to control the delivery of power from the one or more distributed energy sources.

10. The system of claim 9, wherein the distributed energy resource control device is further configured to:
determine, based on the condition, to execute a multi-stage optimization process to control the delivery of power from the one or more distributed energy sources, wherein a first stage of the multi-stage optimization process comprises the generation of the plurality of trajectories for the time interval, and a second stage of the multi-stage optimization process comprises the generation of the plurality of short-term trajectories based on the condition.

11. The system of claim 9, wherein the distributed energy resource control device is further configured to:
apply the optimization function to maintain the local power quality at the site to generate the one or more commands to control the delivery of power from the one or more distributed energy sources.

12. The system of claim 8, wherein the distributed energy resource control device is further configured to:
translate the short-term trajectory to a control setting to generate the one or more commands.

13. A method, comprising:
receiving, by a distributed energy resource control device, from a data processing system of an electricity distribution grid that is remote from the distributed energy resource control device located at a site, an operational constraint, wherein the distributed energy resource control device is located at the site connected with the electricity distribution grid;
generating, by the distributed energy resource control device, for a time interval, a plurality of trajectories for characteristics of electricity at the site based on the operational constraint and bounds for local power quality at the site;
detecting, by the distributed energy resource control device, in real-time during the time interval, a condition related to the characteristics of electricity at the site; and
controlling, by the distributed energy resource control device, in real-time and responsive to the detection, during the time interval, delivery of power from one or more distributed energy sources located at the site based on i) one or more of the plurality of trajectories, ii) the detected condition, and iii) the bounds for local power quality at the site.

14. The method of claim 13, comprising:
controlling, by the distributed energy resource control device, the delivery of power in accordance with the plurality of trajectories based on a rolling-horizon comprising a plurality of time intervals within the time interval.

15. The method of claim 13, comprising:
generating, by the distributed energy resource control device, the plurality of trajectories for the time interval having a first duration; and
generating, by the distributed energy resource control device, a command to control the delivery of power from the one or more distributed energy sources based on a short-term optimization forecast having a second duration that is less than the first duration.

16. The method of claim 13, comprising:
using, by the distributed energy resource control device, a stochastic programming function to generate the plurality of trajectories, wherein the stochastic programming function is configured to account for uncertainty related to load and photovoltaic generation estimates.

17. The method of claim 13, comprising:
generating, by the distributed energy resource control device, the plurality of trajectories using at least one of a regression technique, a decision tree, or a neural network.

18. The method of claim 13, comprising:
generating, by the distributed energy resource control device, a short-term trajectory based on the condition and the plurality of trajectories; and
generating, by the distributed energy resource control device, one or more commands to control the delivery of power from the one or more distributed energy sources in accordance with the short-term trajectory.

19. The method of claim 18, comprising:
generating, by the distributed energy resource control device, a boundary based on the plurality of trajectories;
generating, by the distributed energy resource control device, a plurality of short-term trajectories based on the condition and the plurality of trajectories; and
generating, by the distributed energy resource control device, via an optimization function applied to the plurality of short-term trajectories based on the boundary, one or more commands to control the delivery of power from the one or more distributed energy sources.

20. A non-transitory computer-readable medium storing processor-executable instructions that, when executed by one or more processors, cause the one or more processors to:
receive, from a data processing system of an electricity distribution grid that is remote from a distributed energy resource control device located at a site, an operational constraint, wherein the site connected with the electricity distribution grid managed by the data processing system;
generate, for a time interval, a plurality of trajectories for characteristics of electricity at the site based on the operational constraint and bounds for local power quality at the site;
detect, in real-time during the time interval, a condition related to the characteristics of electricity at the site; and
control, in real-time and responsive to the detection, during the time interval, delivery of power from one or more distributed energy sources located at the site based on i) one or more of the plurality of trajectories, ii) the detected condition, and iii) the bounds for local power quality at the site.
